(19) United States
(12) Patent Application Publication
(10) Pub. No.: US 2012/0310757 A1
(43) Pub. Date: Dec. 6, 2012

(54) METHOD FOR CONTROLLING STORES AND SYSTEM FOR THE SAME

(75) Inventors: Uniyoung KIM, Seoul (KR); Saehun Jang, Seoul (KR); Gangseub Lee, Seoul (KR); Hyungnam Lee, Seoul (KR)

(73) Assignee: LG ELECTRONICS INC.

(21) Appl. No.: 13/486,834

(22) Filed: Jun. 1, 2012

(30) Foreign Application Priority Data
Jun. 3, 2011 (KR) 10-2011-0053794

(51) Int. Cl. G06Q 20/18; G06Q 20/20; G06F 17/30

(52) U.S. Cl. 705/17; 235/375; 705/18

(57) ABSTRACT

A method and system for managing and controlling a store are disclosed. In a store controlling system comprising a digital signage display configured to communicate with a user or a user terminal and to provide a user interface, and a managing system configured to communicate with the digital signage display, so as to manage and control the store, the method for controlling a store includes the steps of authenticating the user or the user terminal, receiving information on a purchase list, outputting product information based upon the received purchase list information, receiving a selection input for purchasing at least one product, generating payment information based upon a basic unit price and a quantity of the at least one product being selected for purchase, and outputting the generated payment information, and processing payment, and controlling a release of the at least one purchased product, when the payment process is completed.

Pursuant to 35 U.S.C. §119(a), this application claims the benefit of the Korean Patent Application No. 10-2011-0053794, filed on Jun. 3, 2011, which is hereby incorporated by reference as if fully set forth herein.

### BACKGROUND OF THE INVENTION

1. Field of the Invention

The present invention relates to digital devices used in stores (or supermarkets) and, more particularly, to a method for controlling stores and a system for the same enabling a user or a user terminal to purchase and receive through a digital interface and/or a managing system in a corresponding store.

2. Discussion of the Related Art

Generally, there exist two different methods for purchasing one or more specific products. One method corresponds to having a purchaser (i.e., user) access an on-line store over the Internet, fill out a purchase order for one or more specific products selected by the purchaser, so that the purchaser can receive the purchased product(s) after a predetermined period of time. Additionally, another method corresponds to having a purchaser visit a traditional marketplace (or street market) and purchase one or more specific products selected by the purchaser, thereby immediately acquiring the purchased items. Most particularly, the second method may be advantageous in that the purchaser can verify the actual products in person, select one or more wanted products, load the selected products in his (or her) shopping cart, thereby purchasing the selected products.

Herein, since a wide range of products are supplied in major department stores or large supermarkets, it is advantageous in that the customers are capable of comparing diverse products and selecting the most preferred products and then purchase the selected products in one place. However, such shopping environment is disadvantageous in that the method of providing information related to the supplied products is generally non-reciprocal (i.e., the information is provided by a one-way communication method). Therefore, the customers may experience difficulty in locating the product(s) he (or she) wishes to purchase. Furthermore, since the cash register is provided only in a fixed location and concentrated in the fixed location, the customers may experience the inconvenience of having to wait for their turn in a waiting line for a considerable amount of time.

Furthermore, in the related art supermarket environment, analog shopping carts are used, and the final payment process for the selected products is each carried out (or performed) and processed by a large number of employees employed by the owner of the corresponding supermarket. Therefore, a solution for accelerating the payment process for the purchased items as compared to the conventional method currently used in supermarkets, and a solution for preventing theft during the payment process are being required.

### SUMMARY OF THE INVENTION

Accordingly, the present invention is directed to a method for controlling stores and a system for the same that substantially obviate one or more problems due to limitations and disadvantages of the related art.

An object of the present invention is to provide a method for controlling stores and a system for the same that can perform two-way information exchange through a digital interface, which can perform interfacing with a user or a user terminal, by using the digital interface and/or a managing system that can communicate with the digital interface.

Another object of the present invention is to provide a method for controlling stores and a system for the same including a faster and smarter payment method and payment system.

Another object of the present invention is to provide a user interface of a digital interface that can be more easily and conveniently used by a user or a user terminal and a communication and/or controlling method using the same.

Another object of the present invention is to define a communication protocol between a digital device displaying the products located in the supermarket and a display device mounted on shopping carts of a supermarket.

Another object of the present invention is to provide a digital system that can prevent products or items located (or displayed) in each aisle of the corresponding supermarket from being lost or stolen.

A further object of the present invention is to define and provide a communication method of a digital signage display and a user interface that can replace the large number of employees working in the corresponding supermarket, thereby minimizing the payment process.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, in a method for controlling a store of a store controlling system, the store controlling system comprising a digital signage display configured to communicate with a user or a user terminal and to provide a user interface, and a managing system configured to communicate with the digital signage display, so as to manage and control the store, the method for controlling a store includes the steps of authenticating the user or the user terminal, receiving information on a purchase list, outputting product information based upon the received purchase list information, receiving a selection input for purchasing at least one product, generating payment information based upon a basic unit price and a quantity of the at least one product being selected for purchase, and outputting the generated payment information, and processing payment, and controlling a release of the at least one purchased product, when the payment process is completed.

In another aspect of the present invention, a recording medium readable by a computer, the computer having data for executing the method of the present invention recorded in the recording medium.

In another aspect of the present invention, a system for controlling a store (or a store controlling system) includes a user terminal configured to include customer information and purchase list information, a digital signage display configured to deliver the customer information and purchase list information to a managing system, and to output product information based upon the purchase list information, and a managing system configured to authenticate a customer based upon the customer information, to generate payment information based upon a basic unit price and quantity of a product selected from the purchase list information and to provide the generated payment information, and to control a release of a purchased product, when a payment process of the product selected for purchase is completed.

In another aspect of the present invention, in a digital signage display configured to communicate with a user or user terminal within a store controlling system and to communicate with a managing system configured to manage and control a store, the digital signage display includes a communication module configured to communicate with the user terminal and the managing system, and a control module configured to perform control operations for aligning information on each product in row or column units, the information being received from the managing system, and for outputting the product information based upon the controlled alignment, and, when a specific product is selected, to perform control operations for outputting a user interface and related information respective to the selected product. Herein, the product information may include at least one of video data including images of the corresponding product, audio data, and text data. And, the text data may include information on a basic unit price of the corresponding product.

In another aspect of the present invention, a display device attachable to a shopping cart includes a communication module configured to receive information on a specific product from a digital device displaying at least one or more products, a code reader configured to recognize code information attached to a random product, a comparison module configured to compare the code information of a product recognized by the code reader with information on the received information on the specific product, a controller configured to generate a first control signal, when it is determined that the information are identical, and to generate a second control signal, when it is determined that the information are not identical, and a display module configured to display a guidance message based upon any one of the control signals generated by the controller.

In a further aspect of the present invention, a method for controlling a digital signage display located in a supermarket includes the steps of detecting a specific shopping cart being equipped with a code reader, a memory, and a communication module, controlling the digital signage display so that communication can be performed between the detected specific cart and the digital signage display, receiving first information and second information, both information being stored in a memory of the specific cart, wherein the first information corresponds to unique ID data being assigned in order to enable the shopping cart to be identified among a plurality of other shopping carts existing in the supermarket, and wherein the second information corresponds to data indicating whether or not payment process for products loaded in the shopping cart can be performed, displaying a first message providing a user with guidance for performing the payment process respective to the products loaded in the shopping cart, when the second information indicates that the payment process can be performed, and displaying a second message informing the user that the payment process respective to the products loaded in the shopping cart cannot be performed, when the second information indicates that the payment process cannot be performed.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates an example of a store controlling system according to the present invention;

FIG. 2 illustrates a general view of an overall system including a shopping cart, a digital signage display, and a server according to an exemplary embodiment of the present invention;

FIG. 3 illustrates an example of a store controlling method according to the present invention;

FIG. 4 illustrates another example of a store controlling method according to the present invention;

FIG. 5 illustrates yet another example of a store controlling method according to the present invention;

FIG. 6 illustrates a further example of a store controlling method according to the present invention;

FIG. 7 to FIG. 9 illustrate examples of a digital signage display according to the present invention;

FIG. 10 and FIG. 11 illustrate exemplary information exchange methods between a user terminal and a digital signage display according to the present invention;

FIG. 12 to FIG. 15 illustrate examples of an actual interface of the digital signage display for controlling the store according to the present invention;

FIG. 16 illustrates a detailed view showing the outside features of a shopping cart according to an exemplary embodiment of the present invention;

FIG. 17 illustrates a general view showing a communication status between a shopping cart and a digital device according to an exemplary embodiment of the present invention;

FIG. 18 illustrates a detailed flow chart showing the process steps of a protocol for data transmission between a shopping cart and a digital device according to an exemplary embodiment of the present invention;

FIG. 19 illustrates a detailed flow chart showing the process steps of a protocol for data transmission between a shopping cart and a digital device according to another exemplary embodiment of the present invention;

FIG. 20 illustrates an example of a user interface provided by the shopping cart shown in FIG. 19;

FIG. 21 illustrates a detailed flow chart showing the process steps of a protocol for data transmission between a shopping cart and a digital device according to yet another exemplary embodiment of the present invention;

FIG. 22 illustrates an example of a user interface provided by the shopping cart shown in FIG. 21;

FIG. 23 illustrates an example of a user interface outputted from the display module shown in FIG. 30;

FIG. 24 illustrates a detailed flow chart showing the process steps of a protocol for data transmission between a shopping cart and a server according to an exemplary embodiment of the present invention;

FIG. 25 illustrates an exemplary process of a display device attached to a shopping cart for controlling motions of the shopping cart according to an exemplary embodiment of the present invention;

FIG. 26 illustrates a general view showing a communication status between a shopping cart and a digital signage display according to an exemplary embodiment of the present invention; and

FIG. 27 illustrates a detailed flow chart showing the process steps of a protocol for data transmission between a shopping cart and a digital signage display according to an exemplary embodiment of the present invention;

FIG. 28 illustrates a method performed by a digital signage display for automatically recognizing and processing purchased and paid products according to an exemplary embodiment of the present invention by the respective time order;

FIG. 29 illustrates a method performed by a digital signage display for automatically recognizing and processing purchased and paid products according to another exemplary embodiment of the present invention by the respective time order;

FIG. 30 illustrates a detailed block view showing an inner configuration module of a display device attachable to a shopping cart according to an exemplary embodiment of the present invention; and

FIG. 31 illustrates a detailed block view showing a structure of a system for controlling a store according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The suffixes “module” and “unit” that are mentioned in the elements used to describe the present invention are merely used for the purpose of simplifying the description of the present invention. Therefore, the suffixes “module” and “unit” may also be alternately used for the reference of a specific element of the present invention.

Reference will now be made in detail to the preferred embodiments of the present invention, examples of which are illustrated in the accompanying drawings. However, the embodiment of the present invention described below may be modified to a wide range of modifications. And, therefore, it should be understood that the present invention will not be limited only to the example presented in the description of the present invention set forth herein.

Although the terms used in the present invention are selected from generally known and used terms, the terms used herein may be varied or modified in accordance with the intentions or practice of anyone skilled in the art, or along with the advent of a new technology. Alternatively, in some particular cases, some of the terms mentioned in the description of the present invention may be selected by the applicant at his or her discretion, the detailed meanings of which are described in relevant parts of the description herein. Furthermore, it is required that the present invention is understood not simply by the actual terms used but by the meaning of each term lying within.

Hereinafter, in the description of the present invention, digital devices that are used in stores according to the present invention and, more particularly, a method for controlling stores and a system for the same enabling a user or a user terminal to purchase and receive a wanted product through a digital interface and/or a managing system within the store, will now be described in detail.

Accordingly, in the description of the present invention, the term “user terminal” is used to refer to all terminals equipped with a communication module, which is capable of performing wireless or wired communication. Examples of such user terminal may include user-owned mobile phones, smart phones, and tablet personal computers (PCs), and also store-owned terminals (or user equipments). Most particularly, the user terminal according to the present invention may refer to a terminal that can communicate with a digital interface and/or a managing system. And, whenever required, the user terminal according to the present invention may download an application or software enabling the user terminal to perform communication with the digital interface and/or managing system, to perform data exchange, and to perform payment processes.

A “digital interface” refers to a device configured to process an input received from a user or a user terminal and to output data related to the received input, or refers to a device configured to perform processing operations in relation with a managing system. Herein, in order to be capable of receiving an input of the user or the user terminal, the digital interface may correspond to an input means including a touch interface, such as a touch-screen or a touchpad, and/or including a non-touch interface, such as a remote controller or a pointer. And, the digital interface may be provided with an operating system (OS), which is required for being in connection with a user or user terminal and/or a managing system and/or for communicating with the user or user terminal and/or the managing system.

Furthermore, the term “managing system” collectively refers to all types of systems performing control operations for processing product purchasing procedures of each user as well as performing the overall store management. Herein, the term “managing system” will be used to refer to a managing system for controlling stores according to the present invention. Meanwhile, in addition to the concept of controlling the stores according to the present invention, the managing system may also be used as a concept of a system for managing the entire store. In the description of the present invention, a Point of Sales (POS) consisting of a terminal, a store controller, a host computer, and so on, will be given as an example of the managing system.

Hereinafter, the present invention will now be described in detail with reference to the accompanying drawings.

Accordingly, an example of the store controlling system (or system for controlling a store) according to the embodiment of the present invention may include a user terminal configured to include customer information and purchase list information, a digital signage display configured to deliver the customer information and purchase list information to a managing system, and to output product information based upon the purchase list information, and a managing system configured to authenticate a customer based upon the customer information, to generate payment information based upon a basic unit price and quantity of a product selected from the purchase list information and to provide the generated payment information, and to control a release of a purchased product, when a payment process of the product selected for purchase is completed. Herein, the digital signage display may directly receive the purchase list information by having the user input the corresponding information by touching a display screen of the digital signage display, or by downloading the purchase list information from the authenticated user terminal through a network by using a pre-decided communication protocol. Also, the digital signage display may output product information, the outputted product information including at least one of video data, audio data, and text data. Herein, the text data may include data corresponding to at least one of product name, unit price, quantity, location, coupon, expiration date.

Additionally, the digital signage display may receive a selection input on a payment method for each product included in the purchase list information, the purchase list information being received from the user terminal. Herein, the payment method may include an online payment method and an offline payment method, the online payment method being processed online through the digital signage display or the managing system within the store, and the offline payment method being directly carried out by the user within the store. Also, when the user selects the offline payment method for a specific product, the digital signage display may download at least one of location information on the specific product and movement path (or course) information from a current location to a location where the specific product is displayed. Herein, the managing system may generate the payment information for a product selected to be purchased by the online payment method, or the managing system may generate the payment information for all products selected to be purchased by both the online payment method and the offline payment method. Furthermore, the user terminal, the digital signage display, and the managing system may exchange information to and from one another by using a wired and/or wireless communication protocol.

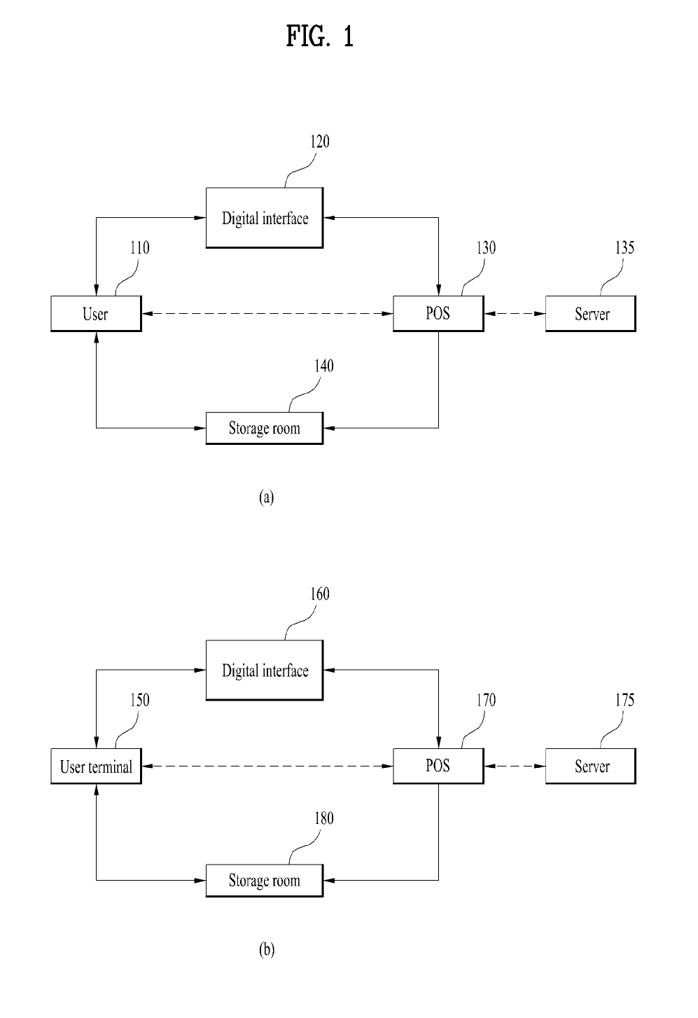

FIG. 1 illustrates an example of a store controlling system according to the present invention.

Herein, the system for controlling stores according to the present invention may further include other elements in addition to the structure shown in FIG. 1. However, the present invention will not be limited only to the system structure shown in FIG. 1, and, as a general rule, the scope of the present invention shall be interpreted and understood based upon the appended claims of the present invention.

Most particularly, as shown in FIG. 1a and FIG. 1b, the method for controlling stores according to the present invention is configured by including digital signage displays 120 and 160 and POSs 130 and 170. However, although the digital signage displays 120 and 160 and the POSs 130 and 170 perform interfacing with the user 110, in FIG. 1a, the digital signage displays 120 and 160 and the POSs 130 and 170 perform interfacing with a user terminal (or user equipment) 150, in FIG. 1b.

An example of the digital signage display, which is capable of communicating with the user or user terminal and with the managing system for managing and/or controlling the store, may include a communication module and a control module. More specifically, the communication module is configured to communicate with the user terminal and the managing system. And, the control module is configured to perform control operations so that information on the products being received from the managing system can be aligned in row or column units and outputted accordingly. And, when a specific product is selected, the control module is also configured to perform control operations so that information related to the user interface (UI) respective to the selected product can be outputted. Herein, the information on the product (or product information) may include at least one of video data, audio data, and text data. And, most particularly, the text data may include basic unit price information of the corresponding product.

Moreover, as shown in FIG. 1a and FIG. 1b, the system for controlling the store according to the present invention may further include storage rooms 140 and 180 and/or servers 135 and 175 receiving control signals (or commands) from the POSs 130 and 170, thereby providing the products that are stored therein.

Herein, the servers 135 and 175 may be configured to support the POSs 130 and 170. For example, when payment information is generated from the POSs 130 and 170, or when the payment process is performed by the POSs 130 and 170, the servers 135 and 175 may correspond to a payment server supporting the provision or processing of data related to the payment process or payment information, or the servers 135 and 175 may also correspond to a store server supporting functions of the POSs 130 and 170 for controlling the store. Furthermore, referring to FIG. 1a and FIG. 1b, although each of the servers 135 and 175 are illustrated as a single structure, the servers 135 and 175 may refer to any one of the above-described server types or may collectively refer to two or more of the above-described server types.

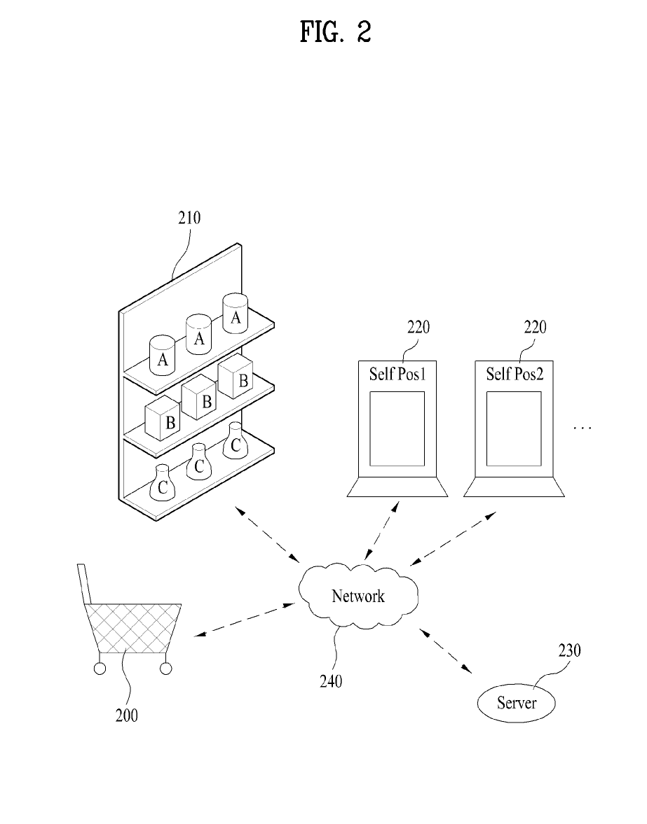

FIG. 2 illustrates a general view of an overall system including a shopping cart, a digital signage display, and a server according to an exemplary embodiment of the present invention.

Hereinafter, an overall system including a shopping cart, a digital signage display, and a server according to the exemplary embodiment of the present invention will now be described in detail with reference to FIG. 2. However, it will be apparent that the elements (or components) shown in FIG. 2 are merely exemplary. And, therefore, the present invention will not be limited only to the elements shown in FIG. 2, and, as a general rule, the scope of the present invention shall be interpreted and understood based upon the appended claims of the present invention.

Referring to FIG. 2, it will be assumed that at least one or more shopping carts 200, at least one or more digital devices 210, and at least one or more digital signage displays (also referred to as “digital signage”) 220 are positioned in a supermarket. In the description of the present invention, for example, the digital device 210 may correspond to an actual display shelf displaying at least one or more products provided and located in a supermarket, or the digital device 210 may correspond to a device being connected to the display shelf. And, herein, for example, a server 230 may be controlled by a subject managing the supermarket.

Also, as shown in FIG. 2, each shopping cart 200, each digital device 210, each digital signage display 220, and the server 230 are connected to one common network. Accordingly, random data may be transmitted and received to and from one another via two-way data communication. Evidently, according to another embodiment of the present invention, the system may be configured so that the shopping carts 200 and the digital device 210 can be connected through a first network, so that the shopping carts 200 and the digital signage display 220 can be connected through a second network, so that the digital signage display 220 and the server 230 can be connected through a third network, and so that the server 230 and the shopping carts 200 can be connected through a fourth network. More specifically, the scope of the present invention includes designing the overall system that each component is inter-connected to one another through different networks.

Moreover, according to the embodiment of the present invention, the digital signage display 220 corresponds to a solution that is newly developed in order to enhance point-of-sales (POS) terminals provided in the related art supermarket environments. Thus, the digital signage technology may resolve the problem of wasting resource, which is caused by payment processes performed by supermarket employees using the POS terminals.

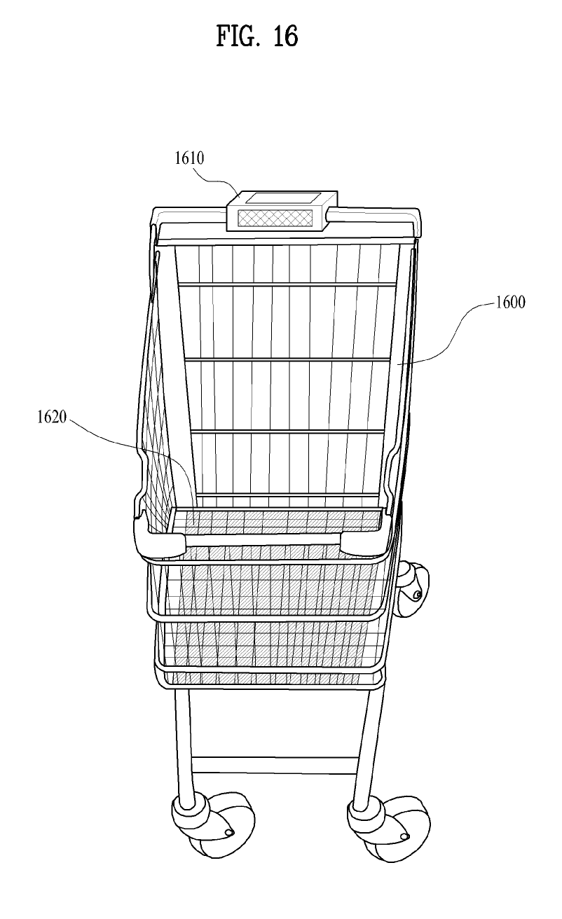

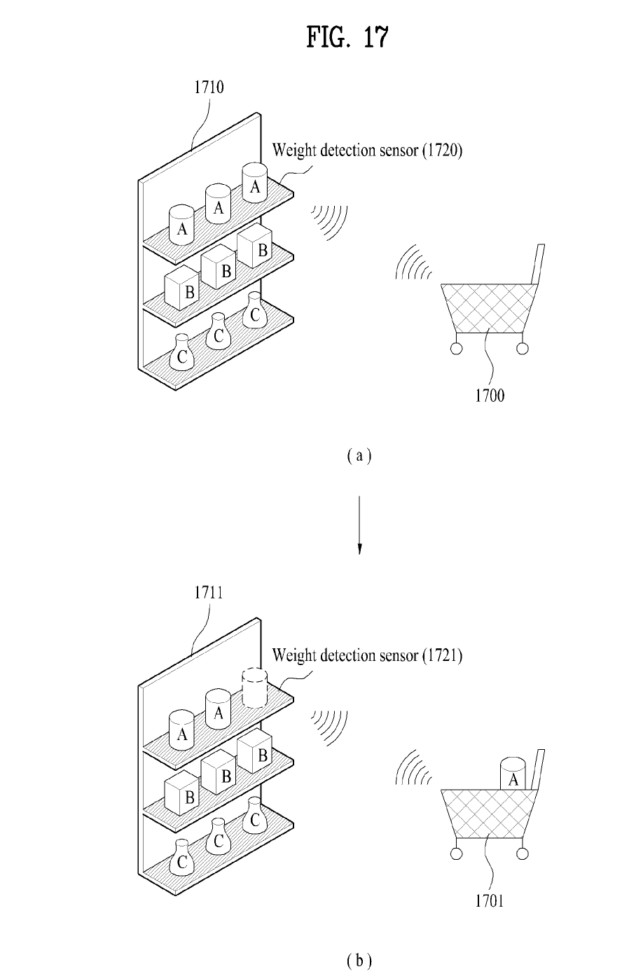

Furthermore, the shopping cart 200 according to the exemplary embodiment of the present invention is designed to have a display device, such as a code reader, and so on, detachably fixed thereto. The above-described shopping cart 200 and the display device will be described in more detail later on with reference to FIG. 16 and FIG. 17.

Hereinafter, a method for controlling a store performed by the store controlling system (or system for controlling stores) shown in FIG. 1 and/or FIG. 2 will now be described in detail.

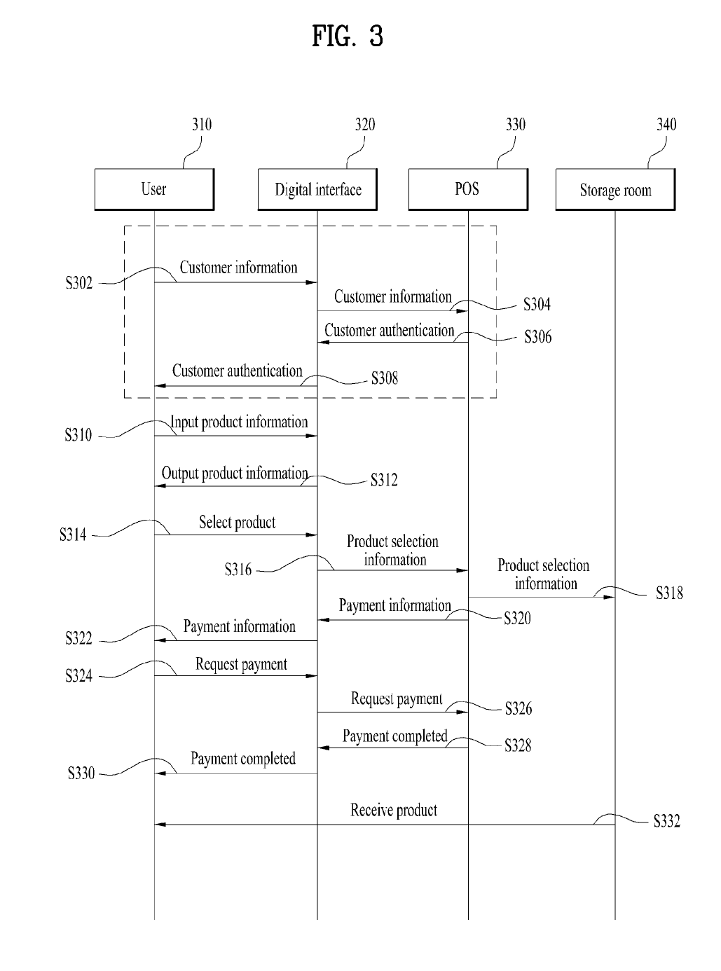

FIG. 3 illustrates an example of a store controlling method according to the present invention.

Most particularly, FIG. 3 shows an exemplary method of controlling a store, when a user 310 purchases a wanted product by using a digital signage display 320, which is provided in a specific area within the store (or supermarket), instead of directly purchasing a wanted product by using a shopping cart within the store.

The user 310 first visits a store (or supermarket) and inputs customer information in a digital signage display 320 that is provided in the store (S302). Herein, the input of the customer information may be performed by having the user 310 directly (or personally) input the customer information by touching the digital signage display 320. Alternatively, the user 310 may have his or her personal information (or customer information) registered in advance in the system of the corresponding store, and, then, the user 310 may tag a card, which carries the registered in formation and is assigned to the corresponding user, or a user equipment (or user terminal), which is registered to the system of the store, on the digital signage display 320.

The digital signage display 320 may, then, deliver the inputted customer information of the corresponding user 310 to the POS 330 (S304). And, the POS 330 authenticates the corresponding customer based upon the delivered customer information (S306 and S308).

Herein, for example, the authentication process determines whether the corresponding customer is a registered customer or a non-registered customer. Then, when it is determined that the corresponding customer is a non-registered customer, the authentication process may include a step of outputting data, which are required for performing the registration process, through the digital signage display 320, so as to notify that the corresponding customer is required to be registered to the store, and a step of requesting additional information that is required for processing the registration process. Thereafter, when the user 310 provides the additional information required to perform registration, the authentication process may be further processed by having the digital signage display 320 deliver the provided additional information to the POS 330, and by having the POS 330 perform the registration process of the corresponding customers. Then, once the registration process is completed, information indicating that the registration process has been successfully completed may be outputted through the digital signage display 320.

The POS 330 generates a registration number assigned to the registered customer and also generates data for processing customer authentication in the future. Then, the POS 330 may provide the generated registration number and data to the user through the digital signage display 320. Herein, when the identification information and the registration information of the registered customer is provided through the digital signage display 320, as described above, information leakage may occur. Therefore, the corresponding information may also be provided by using a different means, such as the user's terminal or e-mail, based upon the provided information of the corresponding user 310.

Accordingly, in step S302, for example, the input of the customer information may be replaced with the input of identification information, which is assigned to the registered customer by the above-described POS 330.

Also, as described above, the user 310 may perform the initial customer registration process through the store's website over the Internet, which is separately provided by the POS 330, or the user 310 may perform the registration process through the digital signage display 320.

Additionally, the digital signage display 320 may also authenticate the customer. In this case, the digital signage display 320 may directly perform the customer authentication process by downloading data or software, which are required for performing customer registration or customer authentication, from the POS 330 or the server.

In this case, the digital signage display 320 may continue to periodically or aperiodically communicate with the POS 330 or the server, so as to update the customer-related data, thereby preventing any problem in the customer registration process or customer authentication process from occurring. Alternatively, the customer information may be updates to the digital signage display 320, only when the customer information has been updated in the POS 330 or server.

The above-described process steps S302 to S308 may also be performed in advance, regardless of the process of controlling the store, as a basic (or essential) procedure that is to be performed prior to the purchase of a specific product according to the present invention.

After performing step S308, the user 310 then performs an actual procedure for purchasing a product.

In other words, when the user 310 inputs information on the product(s) he or she wishes to purchase to the digital signage display 320 (S310), the digital signage display 320 outputs information respective to the wanted product(s) based upon the inputted information (S312).

Herein, for example, as an input means for inputting the product information respective to the product wanted by the user 310, the digital signage display 320 may provide the corresponding information in a touch-type keyboard format. Alternatively, the digital signage display 320 may provide a list of preferred items (or products) based upon a list of purchase history of the customer, who is certified in the above-described certification process.

In this case, by providing a list of preferred items based upon the customer's preference, i.e., by categorizing the corresponding products by a categorization order based upon the products that have recently been purchased most frequently, or by categorizing the corresponding products by a categorization order based upon the most frequently purchased items (or products), or by providing a list of preferred items based upon an alphabetical order (either Korean or English) based upon the most the digital signage display 320, the user may be provided with simplicity and convenience in the user's input or selection.

Alternatively, when an icon or item representing a list of preferred products is provided in a predetermined area within a display screen, and when the user selects the corresponding icon or item, the digital signage display 320 may provide a list of preferred products as described above.

Additionally, the digital signage display 320 may also be provided with a separate icon or item representing a list of recommended products, so as to be capable of providing the customers with a list of special discount items (or products) or a list of items purchased by a large of customers on a particular day or during a particular time period in the corresponding store.

Furthermore, when the user uses the above described means so as to input a specific word, the digital signage display 320 may provide a list of products related to the inputted word.

Accordingly, in providing a list of products related to information (or word) inputted by the user 310, the digital signage display 320 may provide text format data, such as manufacturer of the corresponding product, name of the product, and so on, and the digital signage display 320 may also provide detailed information on the selected product, such as image data of the selected product, location information of the display shelf displaying the selected product, and so on.

As described above, when the user 310 selects a specific product based upon the product information, which is being outputted from the digital signage display 320 (S314), information on the selected product, i.e., product selection information is delivered to the POS 330 (S316).

At this point, when the user 310 selects a specific product, the digital signage display 320 may provide the user with convenience in performing product selection by providing information on the price of the selected product, the number (or amount) of the selected product, and an estimated payment amount respective to the selected product.

The delivery of the product selection information from the digital signage display 320 to the POS 330 may be performed in order to generate payment information, and the delivery of the product selection information may also be perform in order to deliver in advance information on the release (or distribution) of the selected product from the storage room 340. Or, the delivery of the product selection information may be performed for both purposes.

However, the digital signage display 320 may directly deliver the above-described product selection information to the storage room 340 without having to pass through the POS 330 so as to induce the release of the selected product. However, in this case, since a failure in processing the payment process may occur, and since a problem of theft may occur, it may be more preferable to release (or distribute) the selected product from the storage room 340, after the product selection information has passed through the POS 330, so that final information indicating payment completion can be received.

Also, the storage room 340 is designed to simply allow the user to receive one or more specific products, which have been selected and paid for via online shopping, from the POS 330 or another block, instead of allowing the user to directly (or personally) purchase one or more products and/or receive the purchased product(s) via offline shopping.

The POS 330 generates payment information based upon the product selection information of the user, which is transmitted from the digital signage display 320 (S322). Herein, the payment information may be performed at the same time as the above-described step S320 or prior to step S320.

Also, in generating the payment information, the POS 330 may also generate the payment information in connection with a payment server.

The POS 330 may output the generated payment information through the digital signage display 320 and may request for the processing of the payment process. In this case, the POS 330 or the digital signage display 320 may provide information on categories of the products selected by the user and a number of the products selected by the user, payment amount respective to a corresponding item (or product), and total payment amount. And, the POS 330 or the digital signage display 320 may also request for a payment means to be selected. Herein, the POS 330 or the digital signage display 320 may request for the payment process to be processed based upon payment means information, which is pre-registered in the customer information, without having to select the payment means.

The user 310 may verify the payment information outputted to the digital signage display 320 and may request for the payment process to be processed, after selecting the payment means or method of payment and after providing the information required to process payment (S324). Thereafter, the digital signage display 320 may deliver the payment request made by the user 310 to the POS 330 (S326).

The POS 330 processes the payment process in accordance with the payment request made by the user 310. Herein, for example, the payment process may be performed by a communication between the POS 330 and an external payment server.

Once the payment process is completed, the POS 330 delivers the payment completion information to the digital signage display 320 (S328). Then, the digital signage display 320 outputs the delivered payment completion information and reports the completion of the payment process to the user 310 (S330).

Once the user 310 verifies the completion of the payment process through the digital signage display 320, the user 310 receives the purchased product, which is released from the storage room 340, at a pre-arranged location (S332). Herein, the pre-arranged location may include, for example, the POS 330.

The description presented above corresponds to an exemplary case when the user may select a product and pay for the selected product through a plurality of digital signage displays 320 provided in the store and not in the POS 330, which correspond to a limited and fixed location for products that are not required to be verified and purchased in person by the user 310 via offline shopping.

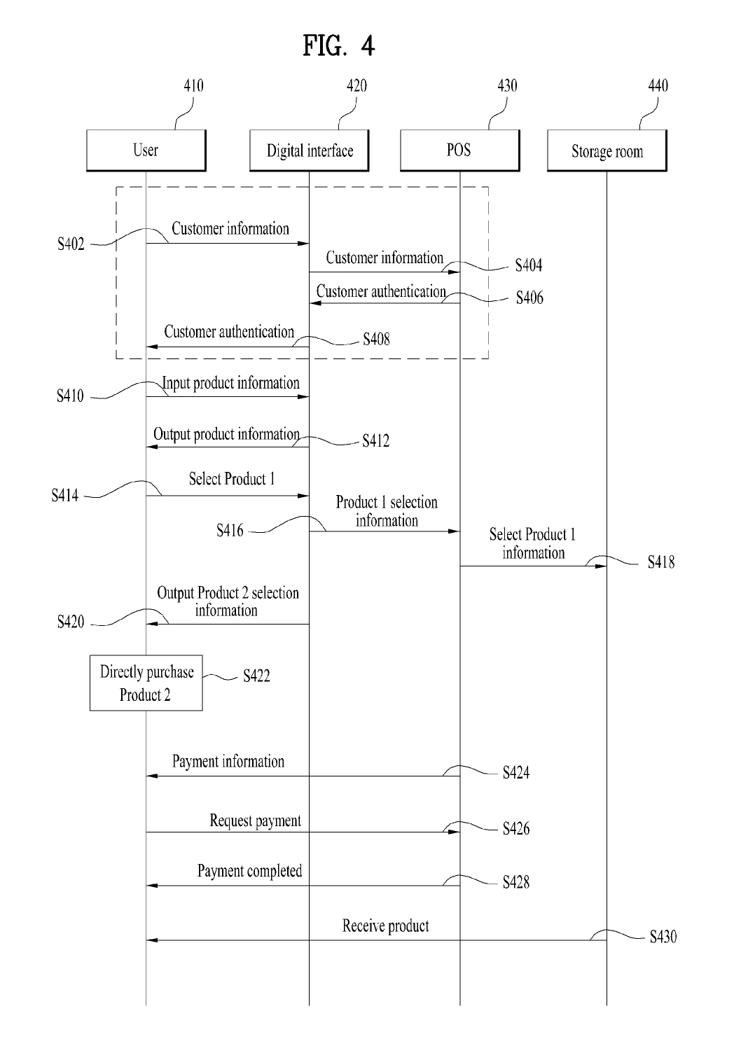

Hereinafter, FIG. 4 illustrates another example of a store controlling method according to the present invention.

Unlike the method shown in FIG. 3, FIG. 4 illustrates a method for controlling a store according to the present invention, wherein the method corresponds to a combination of an offline shopping method and an online shopping method.

In the following description, reference may be made to the description of FIG. 3 for any identical process steps, and, therefore, detailed description of the same will be omitted for simplicity.

First of all, the customer certification and verification processes of steps S402 to S408 shown in FIG. 4 are identically performed as the process steps S302 to S308 shown in FIG. 3.

Thereafter, the user 410 inputs product information (S410), and the digital signage display 420 outputs the corresponding product information (S412).

The user 410 then selects a product based upon the product information outputted on the digital signage display 420 (S414).

Herein, for example, in outputting the product information, the digital signage display 420 may allow the user to select the corresponding product, or the digital signage display 420 may allow the user to select online and/or offline purchase along with the product information.

Hereinafter, for example, a product selected by the user 410 via online purchase will be referred to as a first product, and a product selected by the user 410 via offline purchase will be referred to as a second product.

When the first product and the second product are selected through the digital signage display 420, in step S414, the digital signage display 420 delivers selection information on the first product and selection information on the second product to the POS 430 (S416).

Among the selection information on the first product and the selection information on the second product, the POS 430 delivers the selection information on the first product, which is related to the online purchase, to the storage room 440. Moreover, the POS 430 may generate payment information based upon the information on the selected first product and the information on the selected second product.

The digital signage display 420 outputs information on the selected second product (S420). In this case, the user may provide location information indicating the sales location (or displayed location) of each product or may provide personal information or contact information of the personnel managing the display shelf of the related product. Also, whenever required, the digital signage display 420 may output the above-described information in a printed format through an output device (e.g., printer), which is provided within the store, or which is provided in another location, and may provide the printed information to the customers (or users).

Subsequently, the user 410 directly purchases the second product (S422).

After the purchasing of the second product, the POS 430 either generates payment information or outputs the generated payment information, so as to request the payment process to be performed (S424).

When the user 410 verifies the outputted payment information and requests for the payment process to be carried out (S426), the POS 430 may directly carry out the payment process, or the POS 430 may communicate with an outside payment server, so as to carry out the payment process. Thereafter, when the payment process is carried out and completed, as described above, the POS 430 outputs payment completion information (S428). And, once the user 410 verifies the completion of the payment process, the user 410 then receives the purchased first product, which is released from the storage room 440, at a pre-arranged location (S432), thereby completing the process of purchasing a product.

In the above-described process, in step S414, when the information on the selected second product is different from the information of the second product, which is actually purchased from a display shelf, the user 410 may correspond to the purchase information on the second product through a near-by digital signage display.

Also, the payment process of step S424 may also be carried out through the digital signage display 420 instead of the POS 430.

The description presented above corresponds to an exemplary method of processing the purchase of a product, when the corresponding product is directly purchased by the user 410 in person via offline shopping, in addition to when the corresponding product is purchased via online payment through the digital signage display 420, and method for controlling the store.

In the description of the present invention, the terms “on-line” and “off-line” have the same definition as the generally used terms on-line and off-line. However, in the description of the present invention, the off-line payment method refers to a method wherein the user verifies and selects, in person, the diverse products displayed on the display shelves provided in the store (or supermarket), decides to purchase the selected product(s), and pays for and receives the purchased products. Conversely, the on-line payment method refers to a method wherein the user performs product selection and payment processes only through a digital signage display.

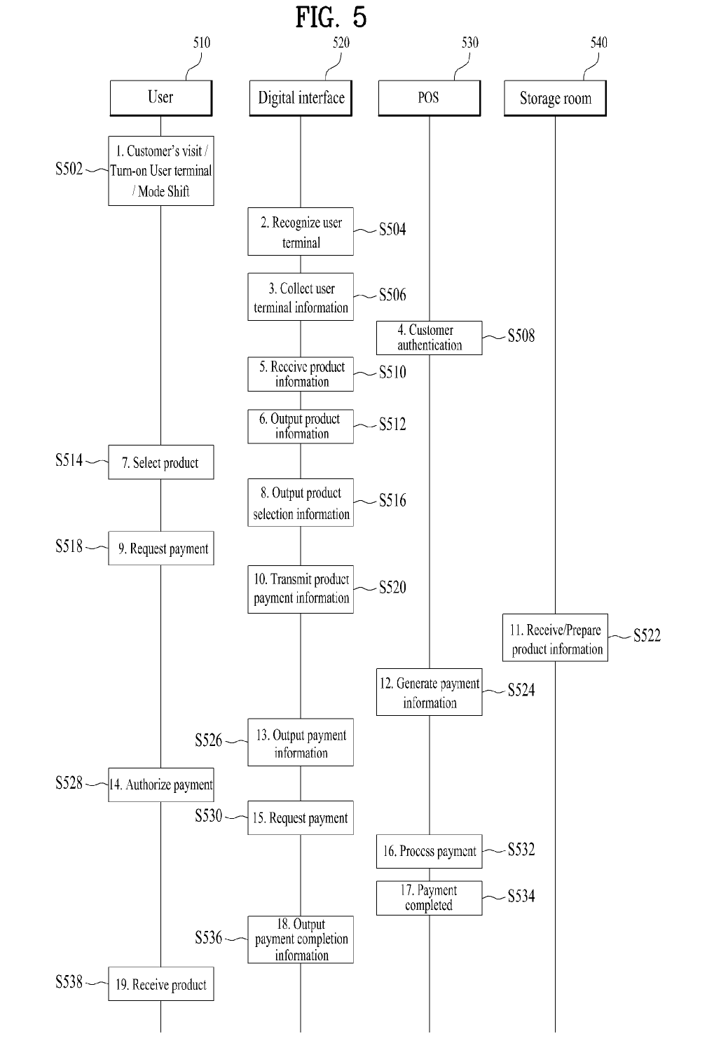

Hereinafter, FIG. 5 illustrates yet another example of a store controlling method according to the present invention.

The example shown in FIG. 5 is similar to the online purchase method of FIG. 3. However, unlike the example of FIG. 3, the example of FIG. 5 corresponds to a case when a product is purchased through an online purchase method using a user equipment (or user terminal) personally owned by the user or provided by the corresponding store. In the following description, reference may be made to the description of FIG. 3 and FIG. 4 for any identical process steps, and, therefore, detailed description of the same will be omitted from FIG. 5 for simplicity.

When a user visits a store, and when the terminal 510 of the user (i.e., user terminal) is turned on, the digital signage display 520 may recognize the user terminal 510 of the user who is visiting the store (S502 and S504). In this case, whenever required, the user may change the operation mode of the user terminal 510 to an operation mode specifically dedicated to the store. Alternatively, the user may also be required to download an application, which is dedicated to be used in the corresponding store, through the internet or through a different means and, then, to execute the downloaded application.

Thereafter, the digital signage display 520 may gather (or collect) customer information, user terminal information, and so on from the recognized user terminal 510 (S506), so as to deliver the gathered customer information, user terminal information, and so on to the POS 530 (S508).

Then, the POS 530 authenticates (or certifies) the customer information, user terminal information, and so on, which are delivered through the digital signage display 520 (S510). Herein, since the operations of the POS 530 and the process steps related to the authentication (or certification) of the user and/or the user terminal are identical to those described in FIG. 3 and FIG. 4, reference may be made to FIG. 3 and FIG. 4, and the detailed description of the same will be omitted for simplicity.

The POS 530 delivers the authentication result of the user terminal 510 to the digital signage display 520, and, based upon the received authentication result, when the authentication is successful, the digital signage display 520 accesses the corresponding user terminal 510 and receives product information (S512).

The digital signage display 520 outputs the product information received from the user terminal 510, in step S512, to a display (or display screen) (S514), and, after verifying the product information outputted on the digital signage display 520, the user may select a wanted (or desired) product (S516).

Thereafter, the digital signage display 520 outputs the product information selected by the user (S518), and, after verifying the outputted information of step S518, the user requests for a payment process to be carried out (S520).

The digital signage display 520 delivers paid product information to the POS 530 based upon the payment request made by the user (S522), and the POS 530 delivers the received paid product information to the storage room 540 and generates payment information based upon the paid product information.

The POS 530 delivers the generated payment information to the digital signage display 520, and the digital signage display 520 outputs the received payment information on a display screen (S526).

Subsequently, after verifying the payment information through the digital signage display 520, the user authorizes the payment process (S528).

The digital signage display 520 requests for the payment process to be carried out, in accordance with the payment authorization made by the user (S530), and, then, the POS 530 communicates with an external server in accordance with the request for carrying out payment made by the user, the request being delivered through the digital signage display, so as to carry out the payment process (S532).

When the payment process is successfully carried out, and when the payment process is completed accordingly (S534), the POS 530 delivers the payment completion information to the digital signage display 520.

After receiving the payment completion information from the POS 530, the digital signage display 520 outputs the payment completion information, which is received from the POS 530, on the display screen (S536). Then, after verifying the completion of the payment process through the digital signage display 520, the user receives the purchased product, which is released from the corresponding storage room 540 (S538).

In the above-described process, each set of information that is outputted on the display screen of the digital signage display 520 is not only provided in the form of image data but may also be provided in the form of audio data along with the image data.

Also, as described above, the digital signage display 520 may also deliver information on the selected product to the POS 530 even before the user request for the payment process to be carried out.

Additionally, since the digital signage display 520 is connected to the user terminal 510 via wired and/or wireless connection, when receiving information on a list of purchased products, which is inputted (or recorded or stored) in advance in the digital signage display 520 by the user, the corresponding information on the list of purchased products may be directly downloaded to the user terminal 510 by changing the operation mode of the user terminal or by executing a respective application. Alternatively, when the digital signage display 520 is connected to the user terminal 510, items corresponds to a folder, which is configured by default settings, may be outputted, so that the user can select a product by using the user terminal 510 or the digital signage display 520.

Furthermore, in the above-described method, only the process of outputting the information on the list of purchased products inputted by the user, the list being downloaded by the digital signage display 520 after communicating with the user terminal 510, and verifying the outputted information on the list of purchased products may be performed. And, the process of having the user select a product may be omitted, so that the procedure for purchasing a product can immediately proceed to the payment process.

The description presented above corresponds to a method for controlling a store by carrying out a process of purchasing a product through a digital signage display by using a user terminal.

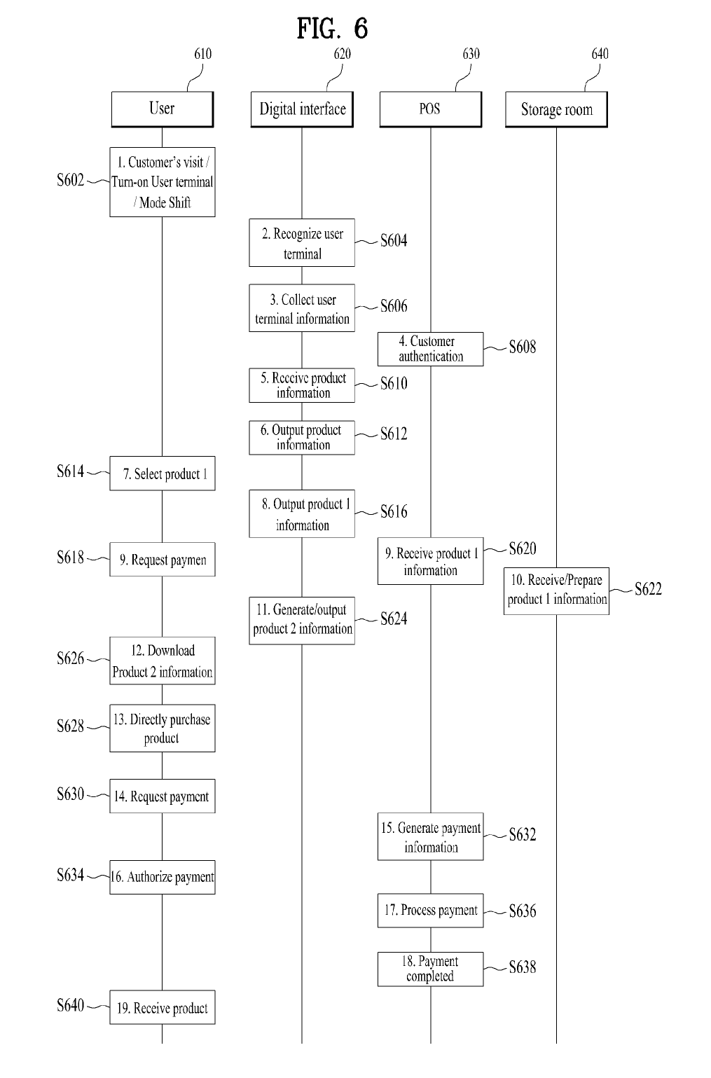

FIG. 6 illustrates a further example of a store controlling method according to the present invention.

Additionally, the example shown in FIG. 6 is similar to the method of purchasing a product by using a user terminal and a digital signage display, as shown in FIG. 5. However, unlike the example of FIG. 4, the example of FIG. 6 corresponds to a case when the purchase method consists of a combination of an online purchase method and an offline purchase method, i.e., in addition to purchasing a product online by using a digital signage display, the user may also directly purchase a product offline. More specifically, FIG. 4 corresponds to an exemplary online purchase method using a user terminal, whereas FIG. 5 corresponds to an exemplary purchase method consisting of both the online purchase method and the offline purchase method.

In the following description, reference may be made to the description of FIG. 3 to FIG. 5 for any identical process steps, and, therefore, detailed description of the same will be omitted from FIG. 6 for simplicity.

Hereinafter, referring to FIG. 6, since the process steps S602 to S612 shown in FIG. 6 are identical to process steps S502 to S512 shown in FIG. 5, reference may be made to the description of FIG. 5 for the description of the corresponding process steps.

After outputting the product information, which is received from the user terminal 610, the user selects a first product, which the user wishes to purchase via online, from the product information outputted to the digital signage display 620 (S614).

Then, the digital signage display 620 outputs information on the first product, which is selected by the user, on a display screen (S616). Thereafter, when the user requests for a payment process to be carried out (S618), the information on the first product (wherein the information includes payment information) is delivered to the POS 630 (S620).

The POS 630 delivers the information on the first product, which is received from the digital signage display 620, to the storage room 640, so as to send a command requesting the storage room 640 to prepare the release of the first product (S622).

In addition to the information on the selected first product, the digital signage display 620 generates information on a second product, which is selected for an offline purchase, and/or outputs the generated information on a display screen (S624).

Herein, for example, the information on the second product, which is generated by the digital signage display 620, includes location information indicating the sales location (or displayed location) of the corresponding product and movement course (or path) information indicating the movement course starting from a current location to the display shelf displaying the corresponding selected product.

The user terminal 610 receives the information on the second product, which is generated by the digital signage display 620, by downloading the corresponding information from the digital signage display 620 (S626).

Based upon the information on the second product, which is downloaded from the digital signage display 620 and stored in the user terminal 610, the user may directly purchase each product offline and in person (S628).

Once the user completes the process of purchasing a wanted product via online and offline, the user may request for a payment process to be carried out with respect to the purchased product (S630).

The POS 630 generates payment information in accordance with the request for carrying out the payment process, which is made by the user, and provides the generated payment information (S632). Then, when the user authorizes the payment process to be carried out (S634), the POS 630 communicates with an external payment server so as to carry out the payment process (S636).

Finally, based upon the payment result, when the payment process has been successfully carried out, the POS 630 provides the payment completion information (S638), and the user verifies the completed payment result and receives the product, which he or she has purchased online (S640).

As described in FIG. 5 and FIG. 6, when the user uses a user terminal, the above-described purchase method and, most particularly, the payment process may be carried out, for example, while the user is consistently moving around the store, by having the user terminal communicate with the digital signage display or the POS via wired and/or wireless communication, without having to directly use only the digital signage display or the POS.

Furthermore, among the above-described processes, personal security and convenience may be ensured during the customer authentication process by using, for example, fingerprint information of the corresponding customer each time the payment process is carried out.

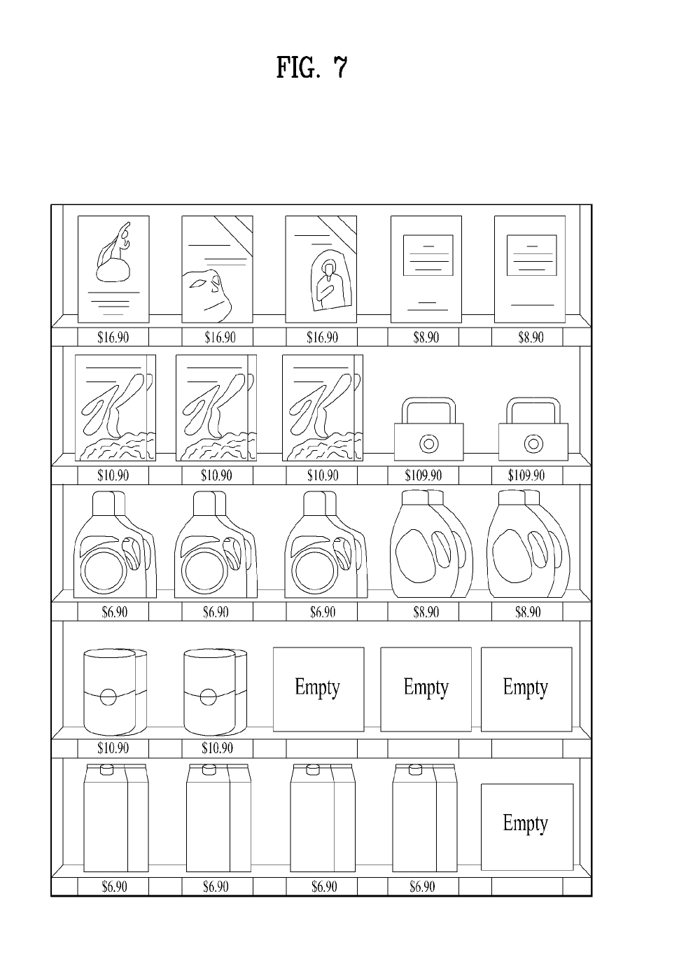

FIG. 7 to FIG. 9 illustrate examples of a digital signage display according to the present invention.

Most particularly, unlike the above-described digital signage, FIG. 7 to FIG. 9 illustrate diverse methods of expression related to providing product information.

Just as the related art display shelves displaying products that could actually be touched by the user, the present invention also digitally exposes products in diverse display shelf formats through a vertical digital signage display. Thus, the user may be provided with information on the corresponding display shelf just as actually going to a supermarket and verifying the displayed products in person, thereby being capable of intuitively viewing purchase information, detailed information, and location information on each product.

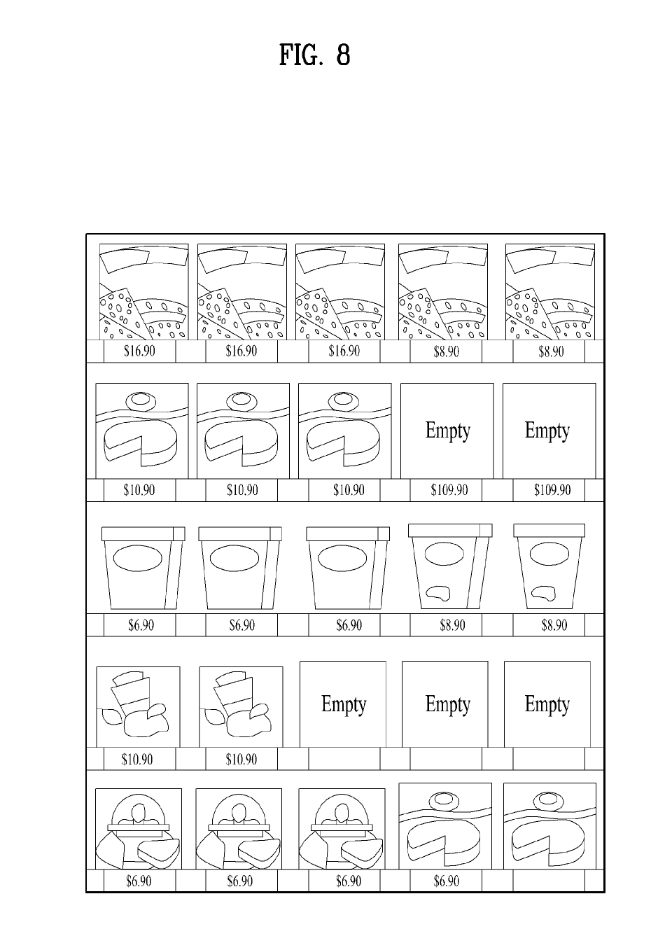

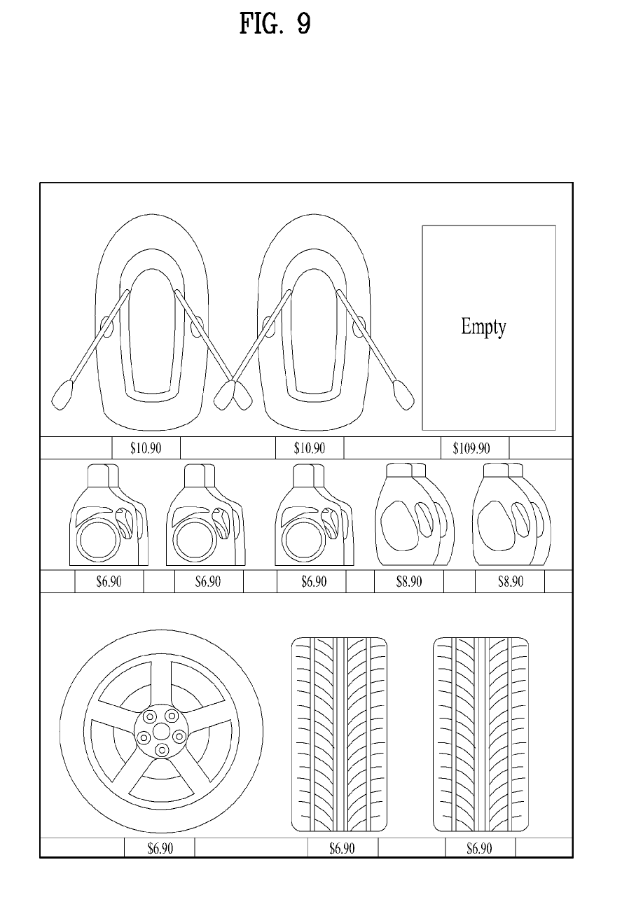

Although FIG. 7 to FIG. 9 respectively illustrate individual forms of digital signage displays, the digital signage displays shown in FIG. 7 to FIG. 9 may also be provided in a combined format. For example, the digital signage displays shown in FIG. 7 to FIG. 9 may be provided along a horizontal direction from left to right, starting from the digital signage display of FIG. 7, which provides a display shelf for non-refrigerated food, followed by the digital signage display of FIG. 8, which provides a display shelf for refrigerated goods, and which is placed in the middle next to the digital signage display of FIG. 7, and then followed by the digital signage display of FIG. 9, which provides a display shelf for providing industrial products, and which is placed in furthermost right side.

Referring to FIG. 7, the digital signage display provides information on non-refrigerated food, which consists of 5 floors (or levels). Herein, each level may provide a digital image for at least one type of product and may also provide price information on each product corresponding to the displayed digital image above or below the displayed image.

Referring to FIG. 8, the digital signage display provides information non-refrigerated food in a display format of a refrigerator, which consists of 5 floors (or levels), which is similar to the digital signage display shown in FIG. 7. Herein, each level may provide a digital image for at least one type of refrigerated product and may also provide price information on each product corresponding to the displayed digital image above or below the displayed image.

Referring to FIG. 9, the digital signage display provides information on industrial products, which consists of 3 floors (or levels). Herein, each level may provide a digital image for at least one type of industrial product and may also provide price information on each industrial product corresponding to the displayed digital image above or below the displayed image.

Additionally, unlike the examples shown in FIG. 7 to FIG. 9, the digital signage display may also be configured of at least one or more columns, instead of being configured of one or more rows.

Herein, although each row may provide information on only one type of product, each column may provide information on different products.

Moreover, the digital signage display may be touch-sensitive by being configured of a touch-screen or a touchpad. For example, the configuration (or layout) of each row, such as the alignment order, the displayed products, and so on may be periodically or aperiodically varied, either based upon the inputted touch of the user, or by the digital signage display itself.

Furthermore, when the user seeks to perform the operations, which are described above with reference to FIG. 3 to FIG. 6, by directly touching the digital signage display or by using his (or her) user terminal, i.e., when the user inputs a request for shift or change in the display mode, the digital signage display may shift to the corresponding display mode, so as to process the user's request.

Also, when the user selects any one of the products provided on the display shelf, the digital signage display enlarges the image of the selected product or highlights the selected product and, then, provides detailed information on the corresponding product.

Also, when a shift occurs in the display mode, or when a specific product is selected, and when providing information on the shifted mode or the selected product, the corresponding information may be provided on the entire display area of the digital signage display. Alternatively, by having the corresponding information being displayed only on a predetermined section of the display area or by shifting the display screen, another user may also be provided with the information related to other products he (or she) wishes to purchase.

Furthermore, the digital signage display may also allow the user to download the detailed information on the specific product selected by the user to the user terminal of the corresponding user.

For example, in order to perform the above-described operation, the digital signage display may be equipped with a close-range sensor. Accordingly, when only one user is detected to be located within the detection range of the close-range sensor, the digital signage display may display the requested information in a more enlarged format. And, when another user is also detected to be located within the detection range of the close-range sensor during a predetermined period of time, the digital signage display may shift to another display screen so as to provide convenience to other users as well.

Furthermore, when the user selects a specific product by using his (or her) user terminal, or by touching the display screen of the digital signage display, the digital signage display may provide a UT related to payment, so that the user can be immediately directed to a payment screen. Thereafter, as described above, by transmitting such payment information to the POS and/or the storage room, the corresponding information may be processed so that the user can receive the purchased product later on at a pre-arranged location on a pre-arranged data. In this case, even though the payment process has not been completed, the digital signage display may provide information related to the product(s) selected for purchase, such as number of purchased products, price of the purchased products, estimated total payment cost (or amount), and so on. Then, when the user chooses to purchase the selected products, the corresponding information may be provided to the POS and/or the storage room, at the point of the final payment process, so that the purchased products can be released from the storage room, and so that the payment process can be completed.

Additionally, the digital signage display may be configured to communicate with the POS, so that the digital signage display can provide, in predetermined time units, information allowing the user to more easily notice and recognize the best-selling products within the store or products corresponding to special coupons or special discount offers.

The digital signage display may also communicate with a sensor or a user terminal, so that the digital signage display can immediately provide a user with detailed information on the products he (or she) may be interested in, based upon the basic customer information stored in the user terminal, or based upon the purchase history or purchase list of the corresponding user, when the user approaches the digital signage display. Alternatively, based upon the age group or physical characteristics of the user, the digital signage display may also vary, change, and re-configure the layout of the products displayed on the digital signage display, so that the customers can easily view and recognize the products and, more specifically, the products that are currently on promotion.

Furthermore, in addition to the unit price, the digital signage display may also provide information on the current storage status of each product.

The description presented above corresponds to the description of the diverse methods used by the digital signage display for presenting the products, when providing the digital images corresponding to the displayed products. However, this is merely exemplary, and, therefore, the present invention will not be limited only to the examples given herein. Accordingly, based upon the overall limited circumstances in time and space, the combined format of the digital signage displays is not required to be limited only to a linear format. And, therefore, the combined format of the digital signage display may also be provided in a polygonal format or a circular format. And, in the future, with more evolution in the digital signage technology, information on the products, which are selected from each of the digital signage displays, may also be provided in a three dimensional (3D) format, or in the form of holograms.

Moreover, instead of flat surfaced (2D) formats, the digital signage displays may also be provided in cubic or volumetric formats (i.e., in 3D formats). Accordingly, by providing the related information on all display surfaces of the digital signage display, space efficiency may be realized, and a larger number of customers may each be provided with the requested or related information at the same time.

Additionally, when an emergency situation occurs, the digital signage display may transmit an emergency message (or urgent message) to the POS, based upon the user's request, so that the emergency situation can be resolved and controlled within a short period of time.

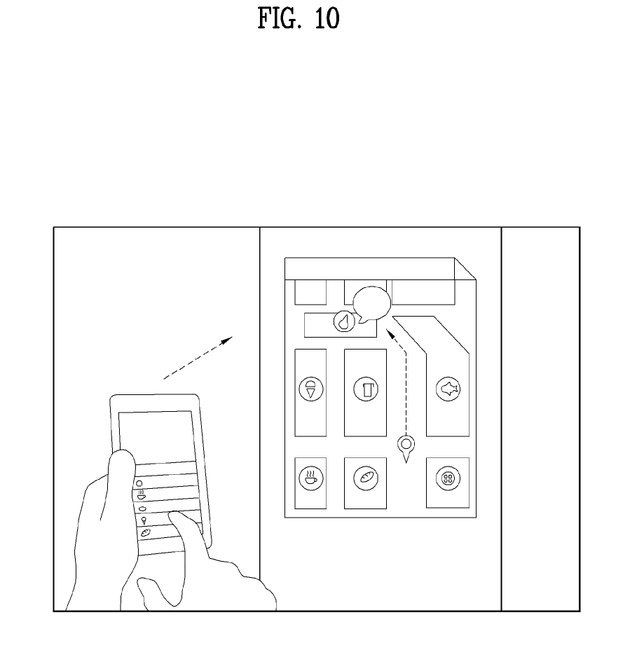

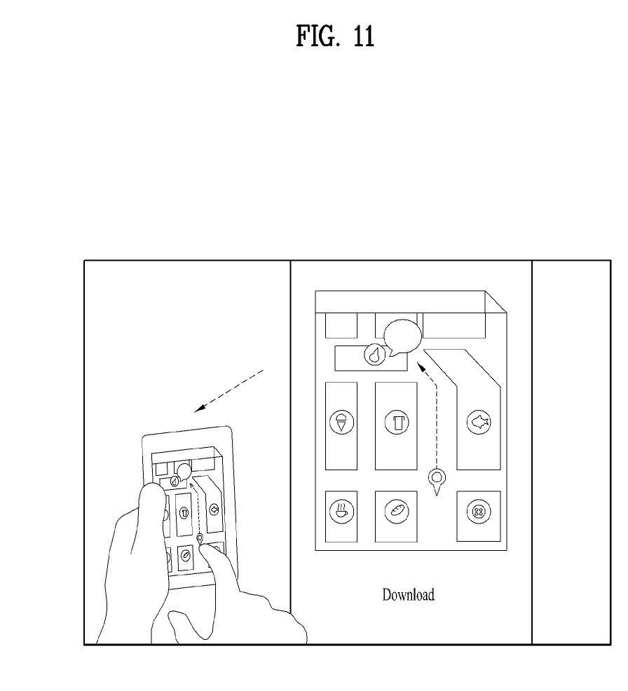

FIG. 10 and FIG. 11 illustrate exemplary information exchange methods between a user terminal and a digital signage display according to the present invention.

The information exchange methods that are to be described with reference to FIG. 10 and FIG. 11, have already been described with reference to FIG. 5 and FIG. 6. Therefore, only the different portions will be described herein, and the description of the similar portions will be omitted for simplicity.

More specifically, referring to FIG. 10 and FIG. 11, a user terminal and a digital signage display is essentially used. Herein, when the user information is automatically or manually inputted, the digital signage display may call out shopping information specifically optimized for the corresponding user.

Additionally, the digital signage display may communicate with the user terminal of the corresponding user, so as to download the related information or to upload information within the user terminal.

For example, in the example shown in FIG. 10, a shopping list, i.e., a purchase list may be uploaded to the digital signage display from the user terminal. And, in the example shown in FIG. 11, after uploading the information of the user terminal, as shown in FIG. 10, optimized information or coupon information may be downloaded to the user.

Herein, as shown in FIG. 10 and FIG. 11, the user terminal and the digital signage display may be connected to one another via wired and/or wireless communication. And, all types of communication protocols designed for close-range communication may be used herein, such as WiBro, TCP/IP, Wi-Fi, Bluetooth, ZigBee, RS232, RS485, and so on.

However, in order to prevent leakage of payment information or customer information from occurring during the information exchange between the user terminal and the digital signage display, the digital signage display may define a separate communication protocol. Then, after downloading the corresponding communication protocol by using a general communication method, the digital signage display may ensure maximized data security on the payment or customer information, through a thorough security and authentication process. Although FIG. 10 and FIG. 11 shows an example of an information exchange between the user terminal and the digital signage display, information may also be similarly or identically exchanged between the user terminal and the POS.

Hereinafter, a detailed description of an actual interface of the above-described method and system for controlling the store according to the present invention will be given.

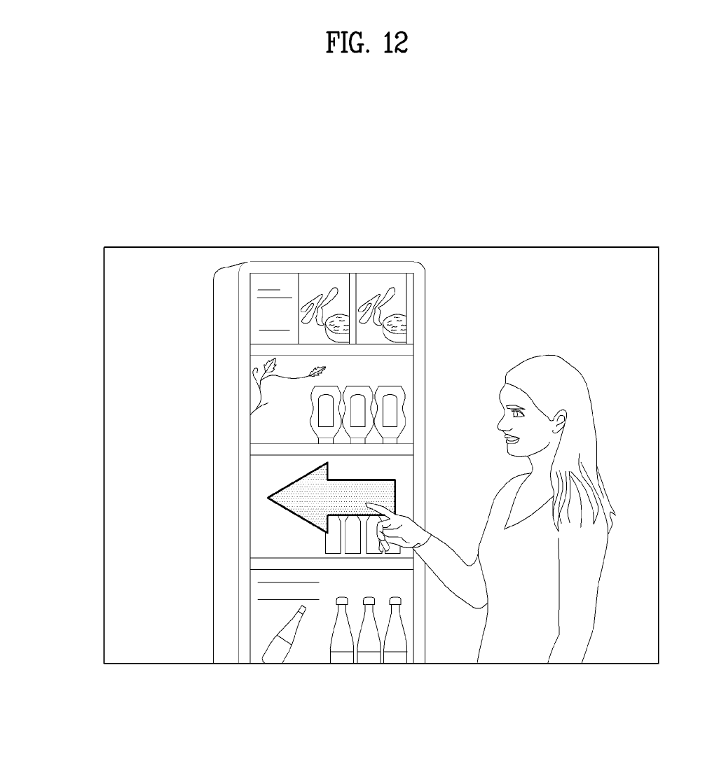

FIG. 12 to FIG. 15 illustrate examples of an actual interface of the digital signage display for controlling the store according to the present invention. Herein, FIG. 12 to FIG. 15 are serially configured for a process of purchasing a product.

Referring to FIG. 12, it will be assumed that the digital signage display is be equipped with a close-range sensor for energy-saving purposes, and that the digital signage display is also equipped with a touch input means.

When a user or user terminal is not detected to be located near the close-range sensor, an initial digital signage display may either turn off the power of the digital signage display or may provide product information at a low (i.e., energy-saving) brightness level.

Then, when a user approaches the close-range sensor, the digital signage display displays product information, which is defined in the default settings.

Referring to FIG. 12, for example, when the user touches the display screen of the digital signage display by gliding his (or her) finger along a direction pointed by the arrow shown in FIG. 12, in order to view other products, the digital signage display may shift to another display screen, so as to provide the corresponding information to the user. In this case, the digital signage display may shift to other products displayed on the same row (i.e., level or floor), or the digital signage display may shift to other products displayed on all rows of the digital signage display.

Additionally, the digital signage display may also provide information on other display shelves by using a flicking method.

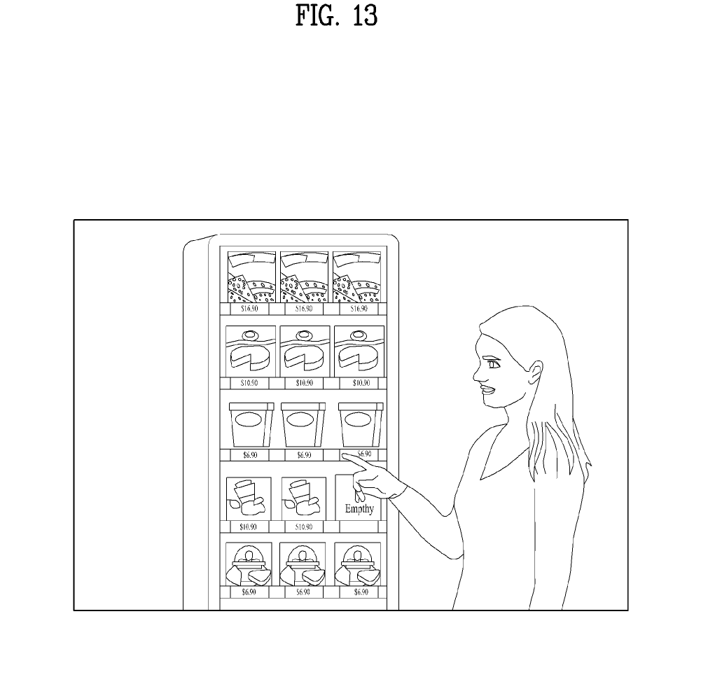

For example, when products provided on a food shelf are displayed on the display screen of FIG. 12, the digital signage display may change the display screen based upon the user's request, thereby displaying products provided on a refrigerator shelf (or refrigerated food shelf), as shown in FIG. 13.

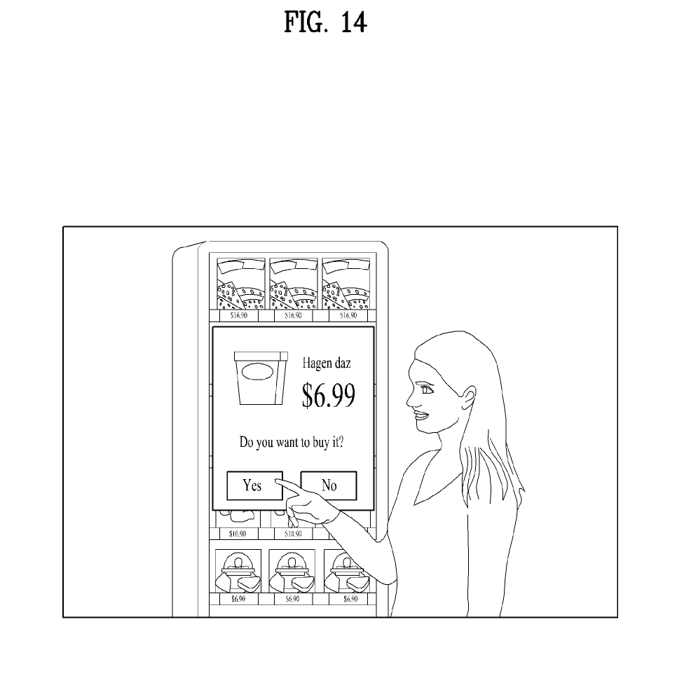

Thereafter, as shown in FIG. 13, for example, when the user selects a specific product from the refrigerator shelf by touching the displayed image of the corresponding product, the digital signage display provides price information on the selected product, as shown in FIG. 14. Then, the digital signage display may provide a user interface (UI) asking the user whether or not he (or she) wishes to purchase the selected product.

Herein, although it is not shown in the drawings, the digital signage display may further provide an item (or option) allowing the user to select the number of products. Alternatively, the user may retouch the corresponding product as many times as the quantity (or number) of the products he (or she) wishes to purchase. Then, after providing information on the payment cost respective to the increased number of products that are to be purchased, the digital signage display may ask the user whether or not he (or she) wishes to purchase the selected products.

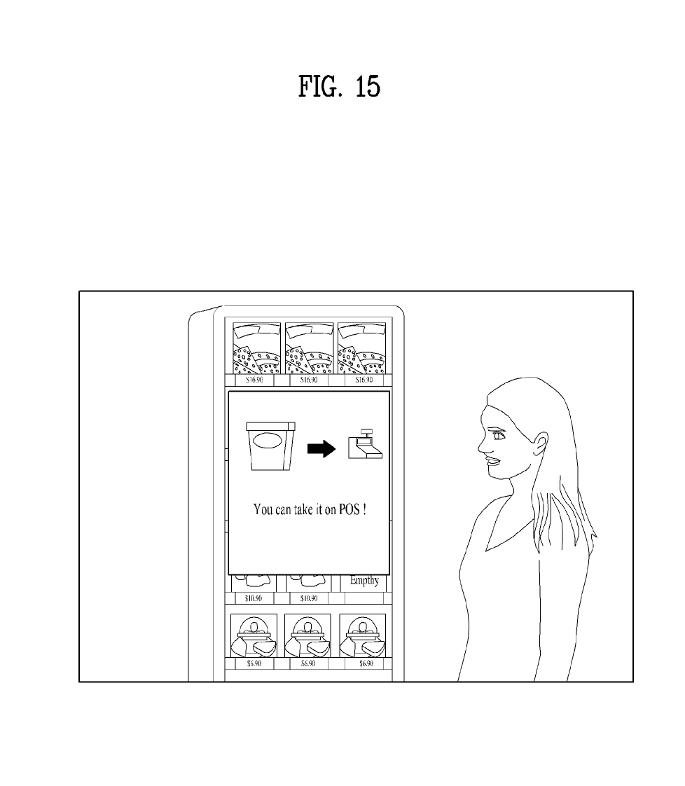

Referring to FIG. 14, when the user chooses to purchase the selected products, the digital signage display may provide a user interface (UI) including information indicating that the user may receive the purchased products from the POS, as shown in FIG. 15.

FIG. 16 illustrates a detailed view showing the outside features of a shopping cart according to an exemplary embodiment of the present invention.

Hereinafter, the overall outside features of the shopping cart according to the exemplary embodiment of the present invention will be described in detail with reference to FIG. 16.

Related art shopping carts are designed according to an analog method, thereby performing the role of simply carrying items. Conversely, as shown in FIG. 16, the shopping cart 1600 according to the embodiment of the present invention is designed to be additionally provided with a display device 1610 and a weight detection sensor 1620. Moreover, the display device 1610 includes a code reader, which can recognize code information attached to a product. And, the display device 1610 is designed to be semi-permanently fixed to the shopping cart 1600 or detachably fixed to the shopping cart 1600.

Therefore, when using the shopping cart 1600 shown in FIG. 16, the problem of wasting human resource by having employees of the supermarket manually use the barcode reader for each purchasing item, so as to perform the final payment process. Furthermore, the payment process may be performed much more quickly.

FIG. 17 illustrates a general view showing a communication status between a shopping cart and a digital device according to an exemplary embodiment of the present invention.

Hereinafter, the communication status between the shopping cart and the digital device according to the embodiment of the present invention will now be described in detail with reference to FIG. 17.

As shown in FIG. 17, the shopping cart 1700 and 1701 and the digital device 1710 and 1711 are designed to perform data communication between one another. As described above, the digital device 1710 and 1711 may correspond to a display shelf displaying the at least one or more products located in the supermarket, or the digital device 1710 and 1711 may refer to a device connected to the display shelf

Moreover, the digital device 1710 and 1711 may include a close-range communication module, which can perform data communication with external devices (e.g., at least one or more shopping carts), and a weight detection sensor 1720 and 1721. Herein, for example, the close-range communication module corresponds to a communication module having a Bluetooth, ZigBee, or NFC communication protocol applied thereto. However, the scope of the present invention will not be limited only to the above-described module. Furthermore, when a random product is missing from a group of products displayed on a specific shelf, the weight detection sensor 1720 and 1721 is used for detecting weight information of the missing product.

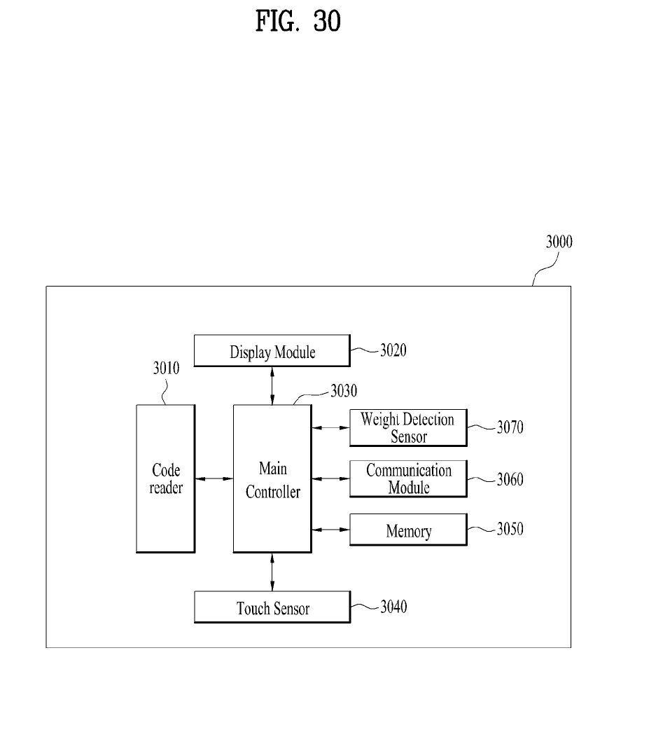

First of all, as shown in FIG. 17(a), it will be assumed that the shopping cart 1700 according to the embodiment of the present invention is located in an area, wherein communication with the digital device 1710 displaying products is available. At this point, for example, the shopping cart 1700 is equipped with the display device 3000 shown in FIG. 30. Therefore, by using the communication module 3060 shown in FIG. 30, the shopping cart 1700 may communicate with the digital device 1710.

Meanwhile, as shown in FIG. 17(b), when a random product displayed on a specific shelf is placed in the shopping cart 1701, the weight detection sensor 1721 of the digital device 1711 may determine that a product corresponding to the decreased weight has been removed from the display shelf. Moreover, the digital device 1711 transmits information on the decreased weight to the shopping cart 1701. Therefore, by using the weight detection sensor mounted on the shopping cart 1701, the shopping cart 1701 may determine whether or not the total weight of the shopping cart 1701 has increased as much as the weight information transmitted from the display device 1711. When designing the present invention as described above, illegitimate (or improper) loading of a product in the shopping cart may be prevented.

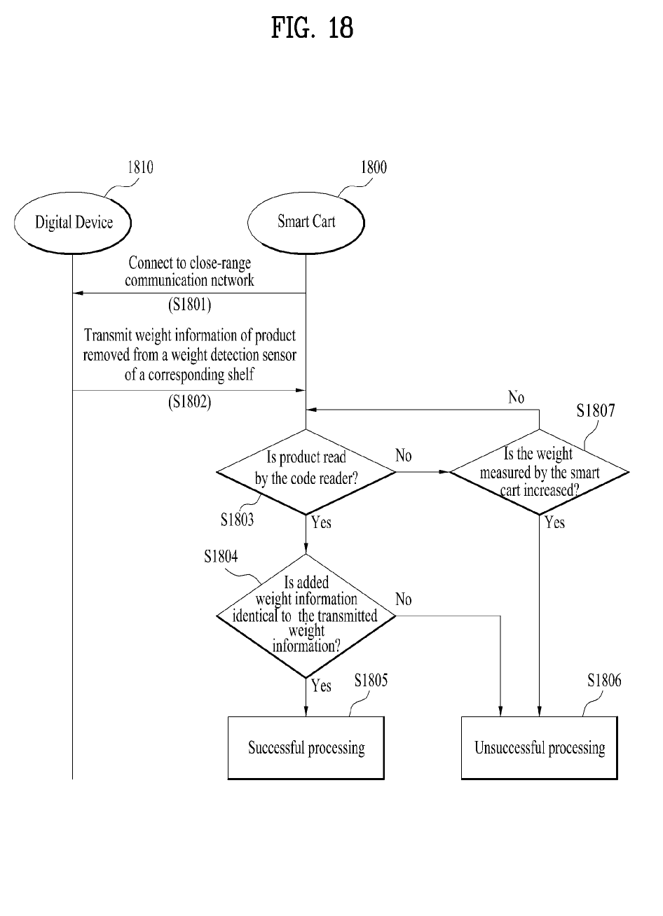

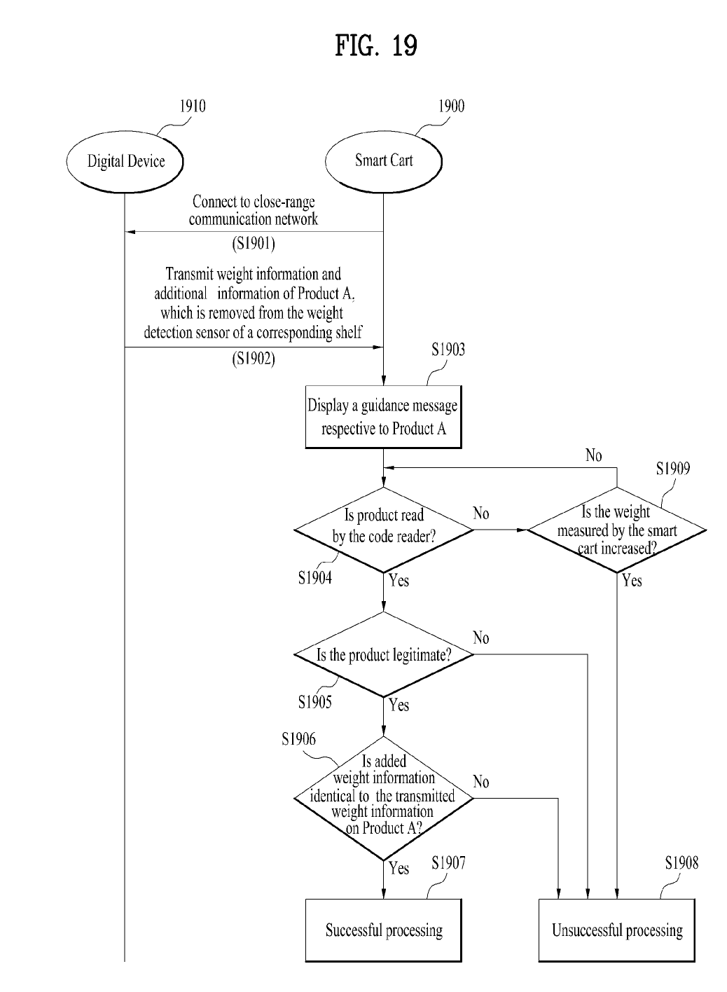

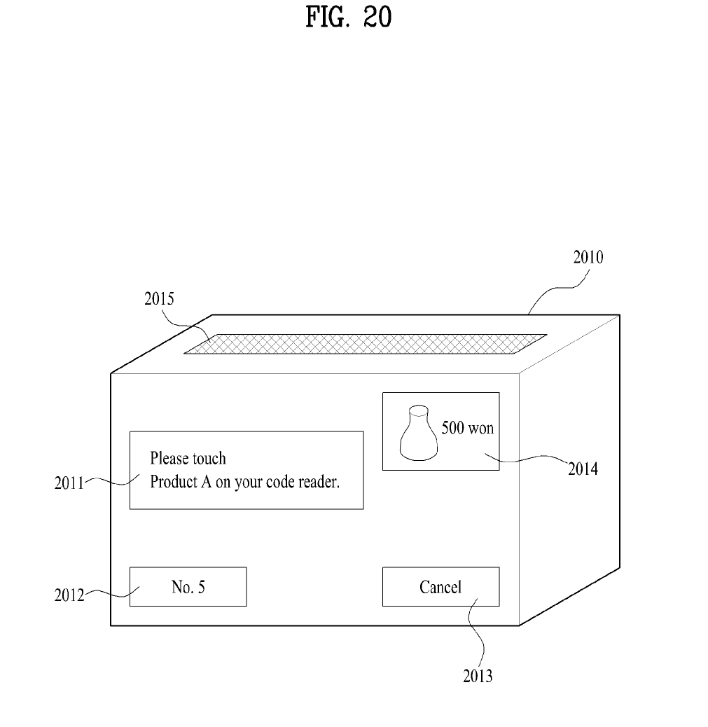

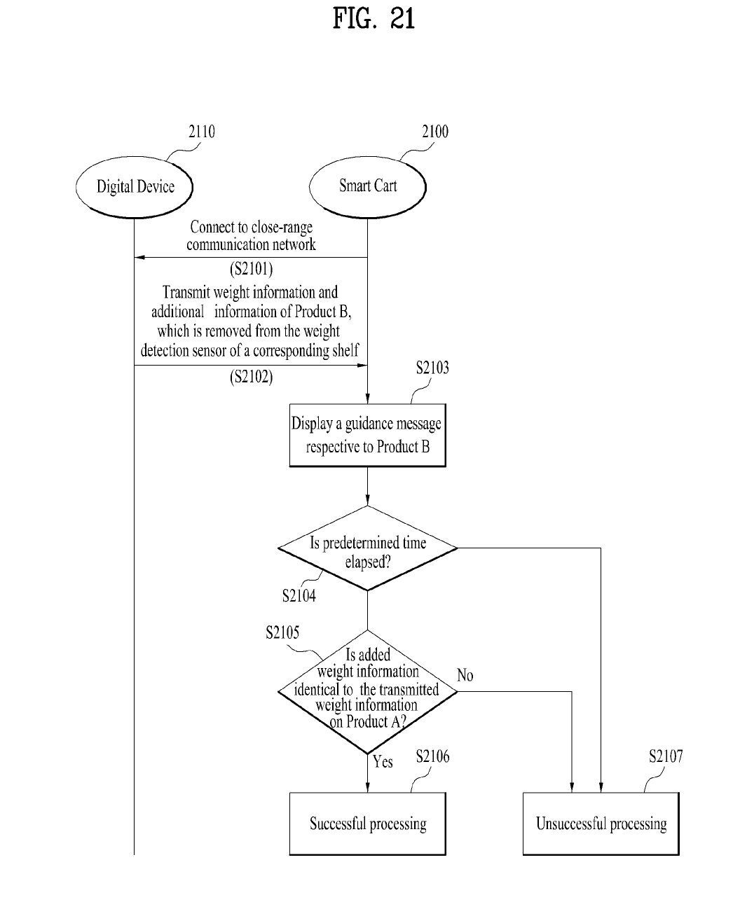

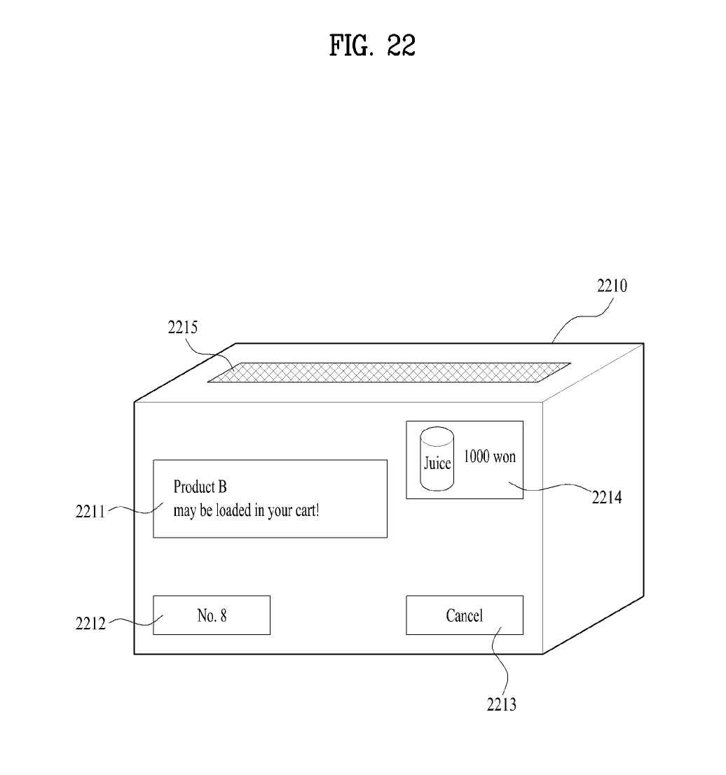

Most particularly, the present invention proposes 3 different solutions for transmitting and receiving data to and from the digital device and shopping cart shown in FIG. 17. This will be described in more detail later on with reference to FIG. 18 (first embodiment), FIG. 19 and FIG. 20 (second embodiment), and FIG. 21 and FIG. 22 (third embodiment).

FIG. 18 illustrates a detailed flow chart showing the process steps of a protocol for data transmission between a shopping cart and a digital device according to an exemplary embodiment of the present invention.

Hereinafter, the protocol for data transmission between the shopping cart and the digital device according to the exemplary embodiment of the present invention will be described in detail with reference to FIG. 18. The steps shown in shown in FIG. 18 are merely exemplary, and, therefore, as a general rule, the scope of the present invention shall be decided by the appended claims of the present invention.

When a shopping cart (also referred to as a smart cart) 1800 according to the embodiment of the present invention, which is located within a supermarket, approaches a digital device 1810 (i.e., when the smart cart 1800 comes within close range of the digital device 1810), a close-range network is connected between the smart cart 1800 and the digital device 1810 (S1801). Therefore, data may be transmitted and received between the above-described smart cart 1800 and the digital device 1810. As described in FIG. 17, when a random item (or product) is removed or misplaced from a specific shelf of the digital device 1810, the digital device 1810 transmits information on the reduced weight, which is recognized by the weight detection sensor, to the smart cart 1800 (S1802).

The smart cart 1800 determines whether or not the random product has been recognized by the code reader (S1803). Then, based upon the result of step S1803, when it is determined that the random product has not been recognized by the code reader, the smart cart 1800 determines whether or not the total weight of the products loaded in the smart cart 1800 has increased (S1807).

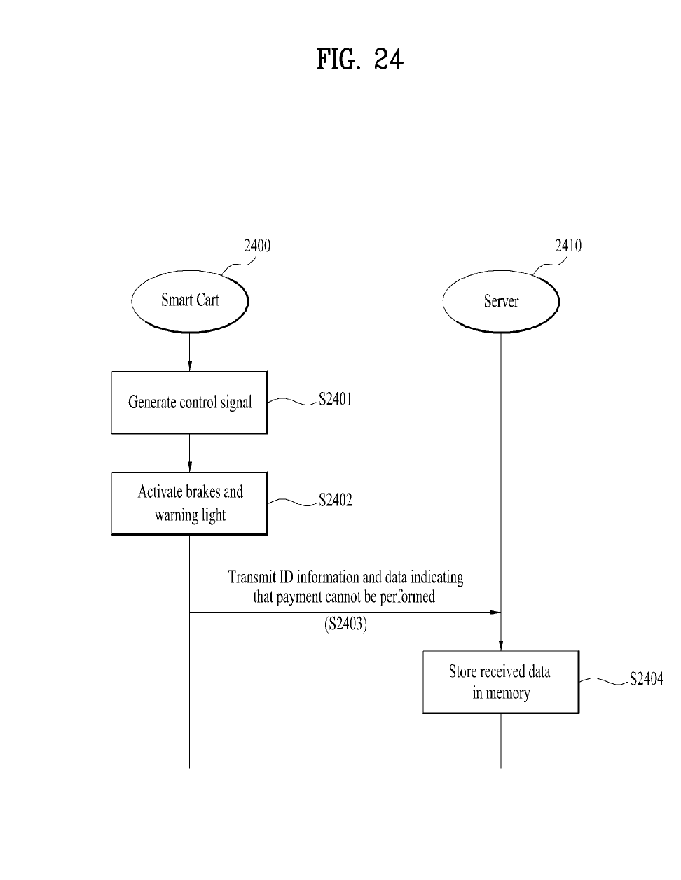

Then, based upon the result of step S1807, when it is determined that the total weight has increased, the smart cart 1800 may recognize that the corresponding random product has been improperly (or unsuccessfully) processed (S1806). Step S1806 will be described in more detail later on with reference to FIG. 24. However, when it is determined that the total weight has increased even though the random product has not been read by the code reader, this design of the present invention may recognize that the corresponding product has been improperly (or illegitimately) loaded in the shopping cart either intentionally or by mistake of the user.

Conversely, based upon the result of step S1803, when it is determined that the random product has been recognized by the code reader, the smart cart 1800 determines whether or not the information on the increased weight, which is detected by the smart cart 1800, is identical to the information on the decreased weight, which is received from the digital device 1810 (S1804).

Thereafter, based upon the result of step S1804, when it is determined that the two weights are identical to one another, the smart cart 1800 may recognize that the corresponding random product has been properly (or successfully) processed (S1805). However, based upon the result of step S1804, when it is determined that the two weights are different from one another, the smart cart 1800 may recognize that the corresponding random product has been improperly (or unsuccessfully) processed (S1806). The solution according to this embodiment of the present invention corresponds to a solution used for identifying a case when products that are touched to the code reader by the user do not match the products that are actually loaded in the shopping cart.

FIG. 19 illustrates a detailed flow chart showing the process steps of a protocol for data transmission between a shopping cart and a digital device according to another exemplary embodiment of the present invention.

Hereinafter, the protocol for data transmission between the shopping cart and the digital device according to the other exemplary embodiment of the present invention will be described in detail with reference to FIG. 19. The steps shown in shown in FIG. 19 are merely exemplary, and, therefore, as a general rule, the scope of the present invention shall be decided by the appended claims of the present invention.

As compared to the embodiment described above with reference to FIG. 18, in addition to the weight information of a specific product, the solution shown in FIG. 19 uses additional information (e.g., product ID, price information, and so on), thereby reducing the possibility of any product being illegitimately (or improperly) loaded in the shopping cart.

When a shopping cart (also referred to as a smart cart) 1900 according to the embodiment of the present invention, which is located within a supermarket, approaches a digital device 1910 (i.e., when the smart cart 1900 comes within close range of the digital device 1910), a close-range network is connected between the smart cart 1900 and the digital device 1910 (S1901). Therefore, data may be transmitted and received between the above-described smart cart 1900 and the digital device 1910. As described in FIG. 17, when a random item (or product) is removed or misplaced from a specific shelf of the digital device 1910, the digital device 1910 transmits information on the reduced weight, which is recognized by the weight detection sensor, and additional information of the corresponding product A to the smart cart 1900 (S1902).

By using the additional information of product A, which is transmitted in step S1902, the smart cart 1900 displays a guidance message or an advertisement message on product A (S1903). Therefore, the smart cart 1900 may inform the user of the corresponding smart cart 1900 of the products that are to be loaded in the smart cart 1900. Hereinafter, step 51903 will be described in detail later on with reference to FIG. 20.

The smart cart 1900 determines whether or not the random product has been recognized by the code reader (S1904). Then, based upon the result of step S1904, when it is determined that the random product has not been recognized by the code reader, the smart cart 1900 determines whether or not the total weight of the products loaded in the smart cart 1900 has increased (S1909).

Then, based upon the result of step S1909, when it is determined that the total weight has increased, the smart cart 1900 may recognize that the corresponding random product has been improperly (or unsuccessfully) processed (S1908). Step S1908 will be described in more detail later on with reference to FIG. 24. However, when it is determined that the total weight has increased even though the random product has not been read by the code reader, this design of the present invention may recognize that the corresponding product has been improperly (or illegitimately) loaded in the shopping cart either intentionally or by mistake of the user.

Conversely, based upon the result of step S1904, when it is determined that the random product has been recognized by the code reader, the smart cart 1900 determines whether or not the additional information transmitted in step S1902 is identical to the information read by the code reader (S1905). Subsequently, based upon the result of step S1905, when it is determined that the two information are not identical to one another, the smart cart 1900 may recognize that the corresponding random product has been improperly (or unsuccessfully) processed (S1908). By adding the above-described step S1905, this solution may prevent products having the same or similar weight from being illegitimately (or improperly) loaded in the shopping cart.

Meanwhile, based upon the result of step S1905, when it is determined that the two information are identical to one another, the smart cart 1900 determines whether or not the information on the increased weight, which is detected by the smart cart 1900, is identical to the information on the decreased weight, which is received from the digital device 1910 (S1906).

Thereafter, based upon the result of step S1906, when it is determined that the two weights are identical to one another, the smart cart 1900 may recognize that the corresponding random product has been properly (or successfully) processed (S1907). However, based upon the result of step S1906, when it is determined that the two weights are different from one another, the smart cart 1900 may recognize that the corresponding random product has been improperly (or unsuccessfully) processed (S1908). The solution according to this embodiment of the present invention corresponds to a solution used for identifying a case when products that are touched to the code reader by the user do not match the products that are actually loaded in the shopping cart.

FIG. 20 illustrates an example of a user interface provided by the shopping cart shown in FIG. 19.

Hereinafter, a user interface provided by the shopping cart shown in FIG. 19 will be described in detail with reference to FIG. 20. For example, the present invention may be designed so that the user interface shown in FIG. 20 can be outputted in step S1903 of FIG. 19.

As described above, the display device shown in FIG. 20 may be designed to be attached to the smart cart 1900 shown in FIG. 19. A display device 2010 that can be mounted on (or attached to) the smart cart may be designed to have a code reader 2015 positioned in a specific area of the display device 2010. Evidently, although the code reader 2015 is located in an upper portion of the display device 2010 in FIG. 20, this is merely exemplary. And, therefore, the scope of the present invention will not be limited only to the exemplary position shown in FIG. 20.

Moreover, the display device 2010 uses the additional information on product A, which is received from the digital device, thereby outputting a guidance message, which notifies the user (or customer) that product A can be loaded in the smart cart. For example, as shown in FIG. 20, the display device 2010 displays an image and price information of product A in a first area (or section) 2014, and the display device 2010 displays a message directing the user to touch product A on the code reader in a second area 2011. Additionally, for customers (or users) who do not wish to purchase product A, the display device 2010 may also display a “Cancel” option in a third area 2013. Moreover, in order to allow the user of the smart cart to easily select the above-described areas, the display device 2010 includes a touch sensor. This will be described later on with reference to FIG. 30.

Furthermore, several tens to several hundreds of the above-described display devices 2010 may be provided within the supermarket. Therefore, in order to identify each of the display devices, the scope of the present invention may also include assigning a unique identification (ID) information to each display device and displaying the assigned ID information in a fourth area 2012.

FIG. 21 illustrates a detailed flow chart showing the process steps of a protocol for data transmission between a shopping cart and a digital device according to yet another exemplary embodiment of the present invention.

Hereinafter, the protocol for data transmission between the shopping cart and the digital device according to yet another exemplary embodiment of the present invention will be described in detail with reference to FIG. 21. The steps shown in shown in FIG. 21 are merely exemplary, and, therefore, as a general rule, the scope of the present invention shall be decided by the appended claims of the present invention.

As compared to the embodiment described above with reference to FIG. 19, FIG. 21 is advantageous in that the user is not required to touch each product to the code reader one by one. Therefore, the payment process may be accelerated and the user convenience may be enhanced.

When a shopping cart (also referred to as a smart cart) 2100 according to the embodiment of the present invention, which is located within a supermarket, approaches a digital device 2110 (i.e., when the smart cart 2100 comes within close range of the digital device 2110), a close-range network is connected between the smart cart 2100 and the digital device 2110 (S2101). Therefore, data may be transmitted and received between the above-described smart cart 2100 and the digital device 2110. As described in FIG. 17, when a random item (or product) is removed or misplaced from a specific shelf of the digital device 2110, the digital device 2110 transmits information on the reduced weight, which is recognized by the weight detection sensor, and additional information (e.g., product ID, price information, and so on) of the corresponding product B to the smart cart 2100 (S2102).

By using the additional information of product B, which is transmitted in step S2102, the smart cart 2100 displays a guidance message or an advertisement message on product B (S2103). Therefore, the smart cart 2100 may inform the user of the corresponding smart cart 2100 of the products that are to be loaded in the smart cart 2100. Hereinafter, step S2103 will be described in detail later on with reference to FIG. 22.

Moreover, the smart cart 2100 determines whether or not a predetermined period of time has elapsed from the point of step S2102 or from the point of step S2103 (S2104). Then, based upon the result of step S2104, when it is determined that the predetermined period of time has elapsed, the smart cart 2100 may recognize that the corresponding product has been improperly (or unsuccessfully) processed (S2107). Evidently, according to another embodiment of the present invention, the above-described step S2104 may be deleted, and the smart cart may be controlled accordingly.

Conversely, based upon the result of step S2104, when it is determined that the predetermined period of time has not elapsed, the smart cart 2100 determines whether or not the information on the increased weight, which is detected by the smart cart 2100, is identical to the information on the decreased weight, which is received from the digital device 2110 (S2105).

Thereafter, based upon the result of step S2105, when it is determined that the two weights are identical to one another, the smart cart 2100 may recognize that the corresponding product has been properly (or successfully) processed (S2106). However, based upon the result of step S2105, when it is determined that the two weights are different from one another, the smart cart 2100 may recognize that the corresponding random product has been improperly (or unsuccessfully) processed (S2107).

When the present invention is designed as shown in FIG. 21, the smart cart or the display device is not required to be additionally equipped with a card reader. Thus, this design of the present invention is advantageous in that the efficiency in using resource can be enhanced. Accordingly, not only the user of the smart cart but also the employees of the supermarket will no longer need to essentially use the code reader.

FIG. 22 illustrates an example of a user interface provided by the shopping cart shown in FIG. 21.

Hereinafter, a user interface provided by the shopping cart shown in FIG. 21 will be described in detail with reference to FIG. 22. For example, the present invention may be designed so that the user interface shown in FIG. 22 can be outputted in step S2103 of FIG. 21.

As described above, the display device shown in FIG. 22 may be designed to be attached to the smart cart 2100 shown in FIG. 21.

A display device 2210 that can be mounted on (or attached to) the smart cart may be designed to have a code reader 2215 positioned in a specific area of the display device 2210. Evidently, when using the smart cart, which is designed in accordance with the embodiment shown in FIG. 21, the display device 2210 may be designed to have a structure that does not include the code reader 2215.

Moreover, the display device 2210 uses the additional information on product B, which is received from the digital device, thereby outputting a guidance message, which notifies the user (or customer) that product B can be loaded in the smart cart. For example, as shown in FIG. 22, the display device 2210 displays an image and price information of product B in a first area (or section) 2214, and the display device 2210 displays a notification message informing the user that product B may be immediately loaded in the smart cart in a second area 2211. As compared to FIG. 20, the message being displayed in the second area may vary. This is because the smart cart according to this embodiment of the present invention, shown in FIG. 22, is designed to recognize product information of a specific product without having to touch the corresponding product on a code reader.

Additionally, for customers (or users) who do not wish to purchase product B, the display device 2210 may also display a “Cancel” option in a third area 2213. Moreover, in order to allow the user of the smart cart to easily select the above-described areas, the display device 2210 includes a touch sensor. This will be described in detail later on with reference to FIG. 30.

Furthermore, several tens to several hundreds of the above-described display devices 2210 may be provided within the supermarket. Therefore, in order to identify each of the display devices, the scope of the present invention may also include assigning a unique identification (ID) information to each display device and displaying the assigned ID information in a fourth area 2212.

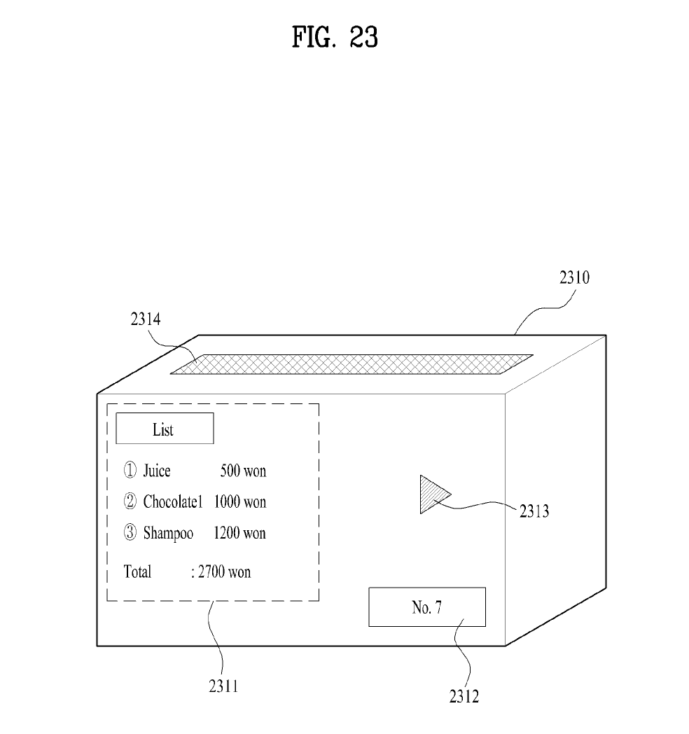

FIG. 23 illustrates an example of a user interface outputted from the display module shown in FIG. 30. Hereinafter, an example of the user interface outputting a display module of a display device, which can be attached to the shopping cart, will be described in detail with reference to FIG. 23.

Information on a product, which has been successfully (or properly) processed in step S1805 of FIG. 18, step S1907 of FIG. 19, and step S2106 of FIG. 21 is stored in a memory of the display device shown in FIG. 23. Herein, the memory will be described in detail later on with reference to FIG. 30. Accordingly, the memory of the display device shown in FIG. 23 accumulates the information on the products that have been successfully processed and stores the respective information.

As shown in FIG. 23, the display device 2310 according to the embodiment of the present invention uses the data stored in the above-described memory, so as to display a graphic showing a list of products that have been successfully processed in a first area (or section) 2311.

Meanwhile, although it is assumed in FIG. 23 that three(3) products (e.g., Juice: 500 won, Chocolate: 1,000 won, and Shampoo: 1,200 won) have been successfully process, in some cases, when there are too many successfully products, it will actually be impossible to output all of the successfully processed products in a single frame. Therefore, in order to resolve this problem, although not all of the products are currently displayed on the display screen, the scope of the present invention may also include displaying an option, which indicates that more successfully processed products exist, in a second area 2313.

Moreover, the memory of the display device 2310 stores unique ID information at a consistent address. Herein, there is no particular limitation in the unique ID information. For example, the unique ID information may be configured in the format of a specific number.

Accordingly, it will be advantageous in that each of the smart carts being equipped with the display device according to the embodiment of the present invention can be easily identified. This will be described in more detail later on with reference to FIG. 24. Evidently, although it is shown in FIG. 23 that the unique ID is displayed in the third area 2313, according to another embodiment of the present invention, the unique ID may also be designed to be displayed only upon special request made by the user.

Furthermore, although it is displayed in FIG. 23 that the display device 2310 is equipped with a code reader 2314, according to another embodiment of the present invention, the scope of the present invention may also include separately equipping the smart cart with the display device and the code reader 2314.

FIG. 24 illustrates a detailed flow chart showing the process steps of a protocol for data transmission between a shopping cart and a server according to an exemplary embodiment of the present invention.

Hereinafter, the protocol for data transmission between the shopping cart and the server according to an exemplary embodiment of the present invention will be described in detail with reference to FIG. 24.

Herein, FIG. 24 shows an exemplary solution for implementing the above-described step S1806 of FIG. 18, step S1908 of FIG. 19, and step S2107 of FIG. 21. Therefore, it will first be assumed in FIG. 24 that a specific product has been improperly (or illegitimately) loaded in the smart cart 2400 according to the embodiment of the present invention.

The smart cart 2400 generates a control signal for processing products that have been unsuccessfully (or improperly) processed (S2401). Then, based upon the control signal generated in step S2401, the smart cart 2400 may be designed to have a visual warning light blink, so as to be visually noticed by the user. Alternatively, based upon the control signal generated in step S2401, the smart cart 2400 may also be designed to have an audible warning sound be outputted, so as to be audibly noticed by the user. Furthermore, the smart cart 2400 may also be designed to have brakes of the smart cart, which are included in the structure of the smart in order to prevent the smart cart from moving, to be mechanically operated so as to stop the smart cart from moving. Evidently, among the above-described methods, the brakes and the warning light may also be designed to be activated and operated at the same time (S2402).

However, considering the complaints that may be conveyed by the user using the smart cart 2400, the scope of the present invention may also include omitting step S2402 and directly processing the payment process from step S2401 to step S2403.

The smart cart 2400 transmits ID information for identifying the corresponding smart cart or display device and also transmit data indicating that at least one or more products is/are improperly (or illegitimately) loaded in the smart cart 2400 to the server 2410 (S2403).

The server 2410 stores the ID information and data transmitted in step S2403 in the memory (S2404). When the smart cart according to the present invention is designed as described above, the smart cart corresponding to the stored ID information may be controlled so that the final payment cannot be processed.

For example, when the smart cart 2400 approaches the digital signage display in order to process the final payment, the digital signage display transmits a request signal to the server 2410. At this point, for example, the request signal may include data inquiring whether or not the final payment for the smart cart assigned with the corresponding ID information can be authorized.

Evidently, in FIG. 24, it is assumed that data indicating the presence of at least one or more successfully processed products, which are loaded in the smart cart, are transmitted from the smart cart 2400 to the server 2410. However, the present invention will not be limited only to the example presented herein.

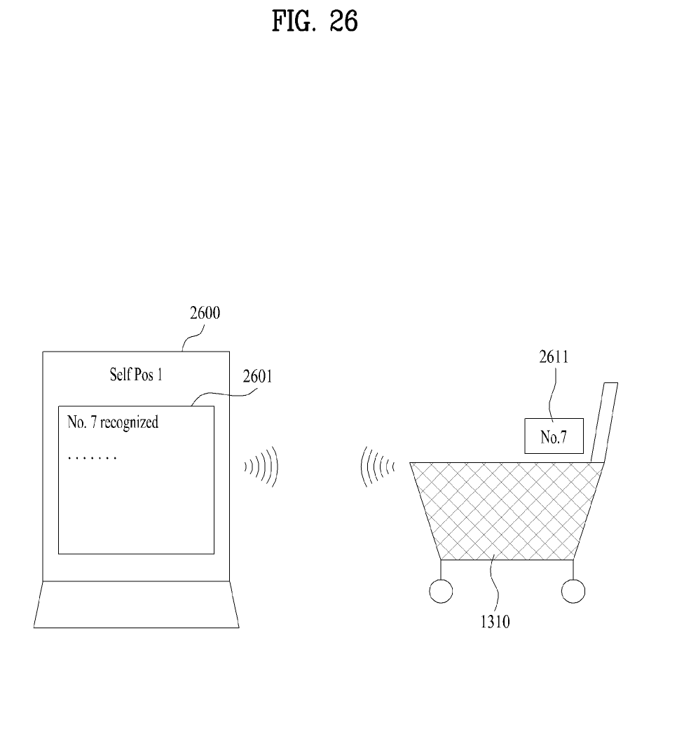

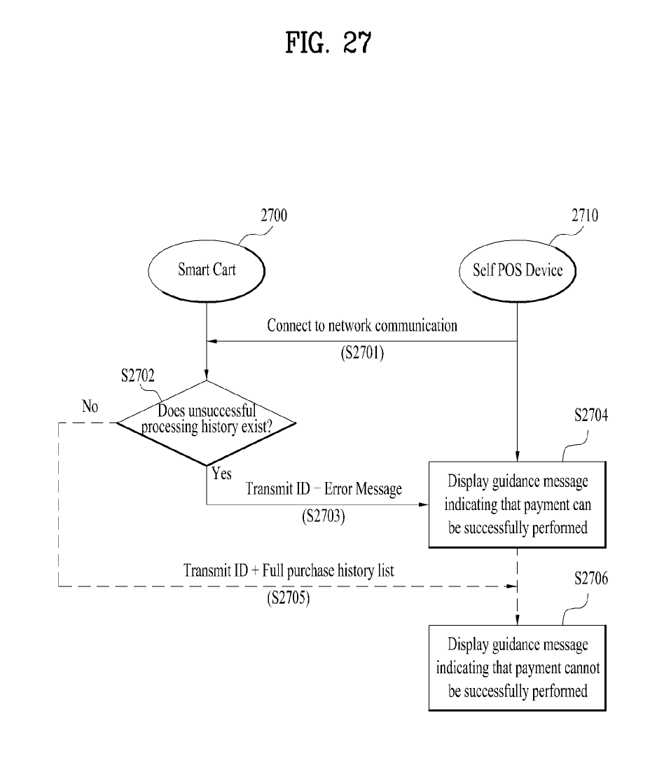

According to another embodiment of the present invention, the present invention may also be designed so that the smart cart 2400 can transmit the data indicating the presence of at least one or more successfully processed products, which are loaded in the smart cart, to the digital signage display in order to process the final payment. This will be described in more detail later with reference to FIG. 26 and FIG. 27.

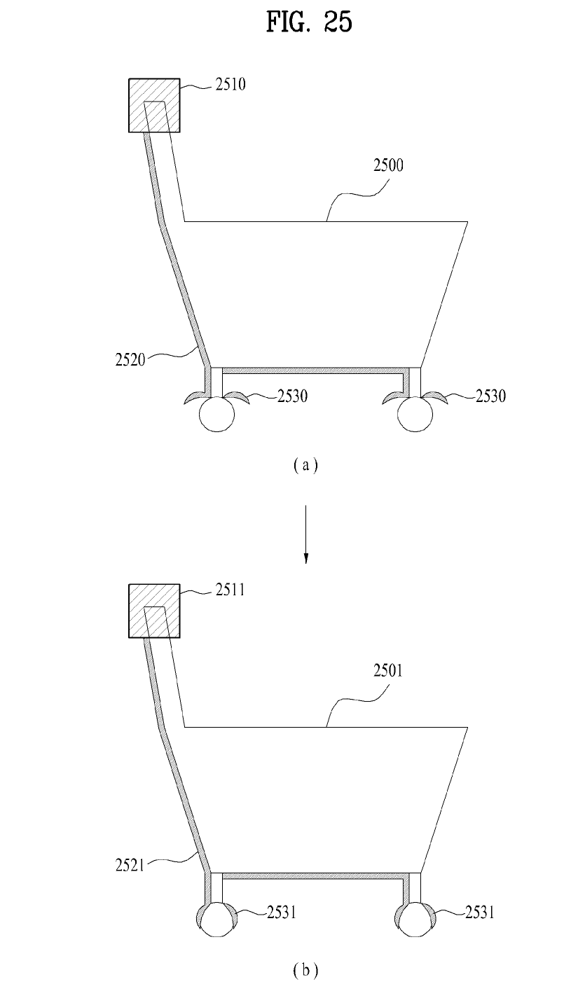

FIG. 25 illustrates an exemplary process of a display device attached to a shopping cart for controlling motions of the shopping cart according to an exemplary embodiment of the present invention.

Hereinafter, the exemplary process of the display device attached to the shopping cart for controlling motions of the shopping cart according to the exemplary embodiment of the present invention will be described in detail with reference to FIG. 25. Most particularly, FIG. 25 corresponds to a detailed solution for implementing step S2502 shown in FIG. 25.

When successfully processed products are only loaded in the smart cart 2500 according to the embodiment of the present invention, as shown in FIG. 25(a), the controller of the display device 2510 maintains a wheel controller 2530 at an open state, which is connected to the display device 2510 through a wired line 2520. Herein, for example, the display device 2510 corresponds to the display device described above with reference to FIG. 16 or FIG. 30.

Meanwhile, when unsuccessfully processed products are also loaded in the smart cart 2501, as shown in FIG. 25(b), the smart cart 2501 generates a specific command. More specifically, the controller of the display device 2511 mounted on the smart cart 2501 generates a command signal for controlling the wheel controller.

Thereafter, the command signal generated by the controller of the display device 2511 is delivered to the wheel controller 2531 through the wired line 2521. Herein, the wheel controller 2531 may also be designed to have its state shifted to a closed state. The closed state of the wheel controller 2531 refers to an angle of the wheel controller 2531 being more narrow within a predetermined range, as shown in FIG. 25(b), so that the wheels of the smart cart cannot move.

FIG. 26 illustrates a general view showing a communication status between a shopping cart and a digital signage display according to an exemplary embodiment of the present invention. Hereinafter, a general description of the communication status between the shopping cart and the digital signage display according to the exemplary embodiment of the present invention will be given in detail with reference to FIG. 26.

As shown in FIG. 26, it will be assumed that a smart cart 2610, which is only carrying successfully processed products or also carrying unsuccessfully processed products, approaches the digital signage display 2600. As described above, the digital signage display 2600 corresponds to a new solution that replaces the related art system processing final payment by having individual employees manipulate POS terminals. More specifically, the digital signage display corresponds to a perfectly unmanned (or unattended) system that does not require any human resource, such as employees of the supermarket.

Moreover, when the smart cart 2610 is located within a wireless network area of the digital signage display 2600, the display device 2611 equipped in the smart cart transmits a specific signal to the digital signage display 2600. Herein, for example, the specific signal may correspond to the unique ID information stored in the memory of the display device 2611. Therefore, after receiving the unique ID information, the digital signage display 2600 may display a guidance message 2601 indicating that a smart cart equipped with the specific display device has been recognized.

As described above, when the display device is designed to display the specific message 2601, the user (or customer) using the corresponding smart cart 2610 may quickly access the specific digital signage display 2600, which has recognized the corresponding smart cart 2610 among the plurality of other smart carts provided in the supermarket.

FIG. 27 illustrates a detailed flow chart showing the process steps of a protocol for data transmission between a shopping cart and a digital signage display according to an exemplary embodiment of the present invention.

Hereinafter, the protocol for data transmission between the shopping cart and the digital signage display according to the exemplary embodiment of the present invention will now be described in detail with reference to FIG. 27.

When the smart cart 2700 according to the embodiment of the present invention is located within close range of the digital signage display (also referred to as a self POS device) 2710, connection may be made to a wireless communication network (S2701).

At this point, the smart cart 2700 primarily determines whether or not an unsuccessfully processed history is recorded in the memory (S2702). Then, based upon the result of step S2702, when it is determined that such history exists, the smart cart 2700 transmits unique ID information identifying the corresponding smart cart 2700 or the display device equipped to the corresponding smart cart 2700 and also transmits an error message to the digital signage display (S2703). Herein, for example, the unique ID information and the error message are stored in the memory included in the display device of the smart cart 2700.

Accordingly, the digital signage display 2710 may display a message informing the user that payment cannot be successfully processed (S2704). Additionally, the scope of the present invention may also include outputting a guidance message, which indicates that re-recognition of each product should be performed by using the code reader of the smart cart, at the same time as the message displayed in step S2704.

Meanwhile, based upon the result of step S2702, when it is determined that the history of any unsuccessfully processed products does not exist, the smart cart 2700 transmits unique ID information identifying the corresponding smart cart 2700 or the display device equipped to the corresponding smart cart 2700 and also transmits a complete payment history list to the digital signage display (S2705). Herein, for example, the unique ID information and the complete payment history list are stored in the memory included in the display device of the smart cart 2700.

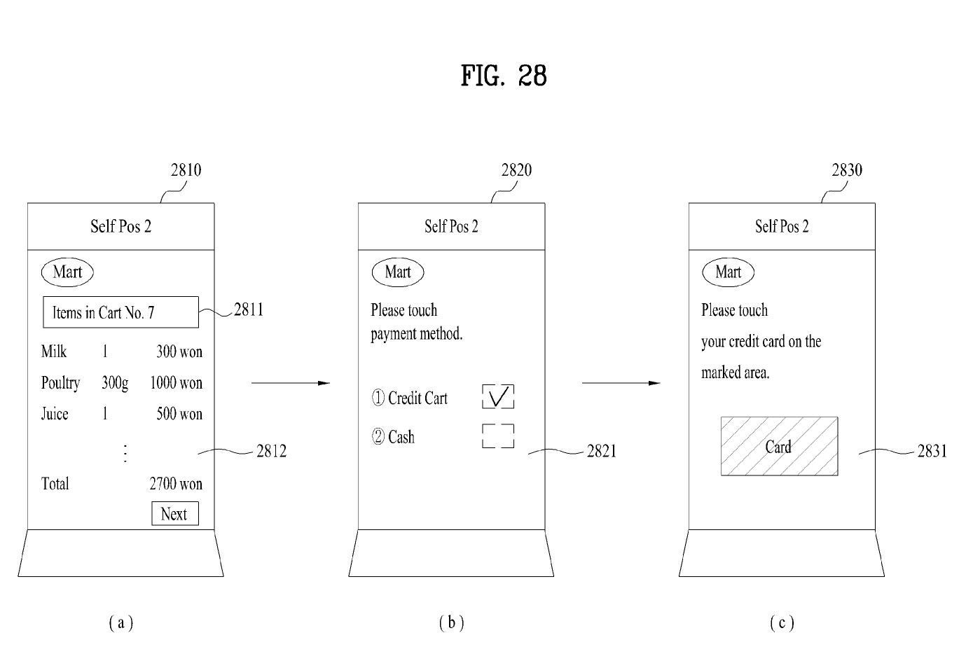

Accordingly, the digital signage display 2710 may display a message informing the user that payment can be successfully processed (S2706). The above-described step S2706 will be described in more detail later on with reference to FIG. 28.

FIG. 28 illustrates a method performed by a digital signage display for automatically recognizing and processing purchased and paid products according to an exemplary embodiment of the present invention by the respective time order.

Hereinafter, the method performed by the digital signage display for automatically recognizing and processing purchased and paid products according to the exemplary embodiment of the present invention by the respective time order will be described in detail with reference to FTG. 28.

As shown in FIG. 28(a), the digital signage display 2810 according to the embodiment of the present invention displays a message 2811 identifying a recognized smart cart. Moreover, the digital signage display 2810 automatically displays a list 2812 of items (or products) loaded in the recognized smart cart, after receiving the list 2812 from the server. Thus, the inconvenience of the related art method of having to touch each item loaded in the shopping cart with the barcode reader may be resolved. Most particularly, an aspect of the present invention is to provide an innovative method of eliminating the waste in time and human resource required in the initial payment process.

When a “Next” option, which is located in a lower area of a display screen shown in FIG. 28(a), is selected, the digital signage display 2820 according to the embodiment of the present invention outputs a message 2821 providing guidance for processing the payment method, as shown in FIG. 28(b). More specifically, the digital signage display shown in FIG. 28 is designed to additionally include a touch sensor that can recognize the touch of a human hand.

Meanwhile, when a “Credit Card” item is selected, as shown in FIG. 28(b), the digital signage display 2830 shown in FIG. 28(c) outputs an on-screen display (OSD) screen 2831 guiding the user (or customer) to a position for touching the user's credit card.

In short, the smart cart according to the other embodiment of the present invention transmits information on the products purchased by the customer (or user) to a database of the server in real time. Therefore, it is advantageous in that a digital signage display, which can communicate with the service, may immediately display the payment information. Also, by using the method proposed in the present invention, the supermarket may prevent in advance the forming of long waiting lines for the final payment.

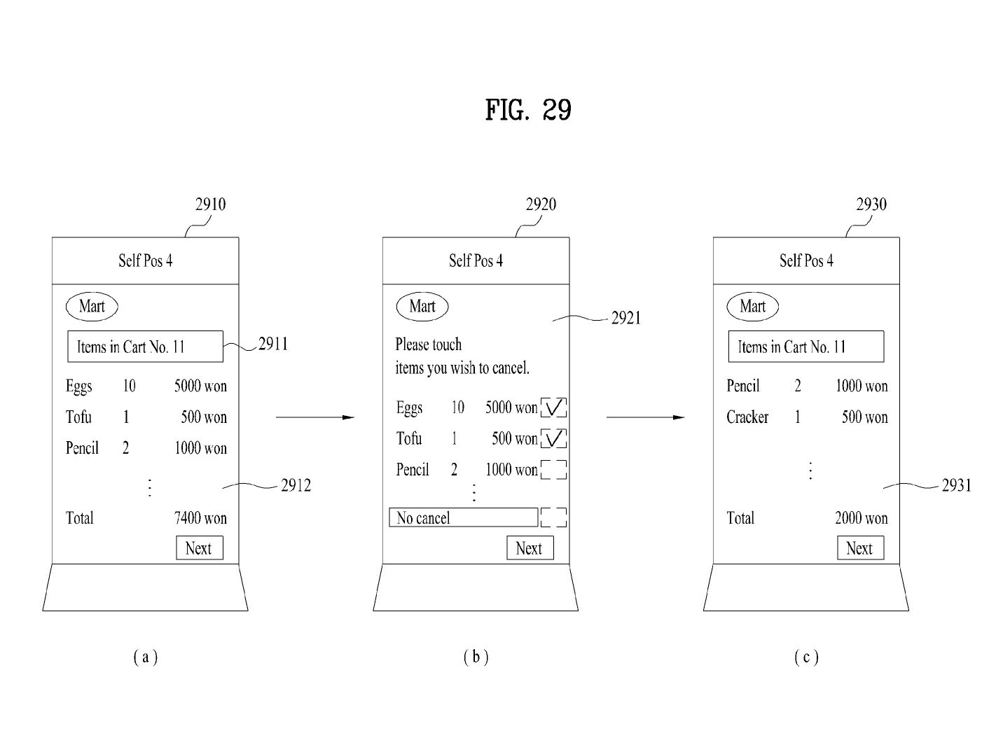

FIG. 29 illustrates a method performed by a digital signage display for automatically recognizing and processing purchased and paid products according to another exemplary embodiment of the present invention by the respective time order.

Hereinafter, the method performed by the digital signage display for automatically recognizing and processing purchased and paid products according to the other exemplary embodiment of the present invention by the respective time order will be described in detail with reference to FIG. 29.

As shown in FIG. 29(a), the digital signage display 2910 according to the embodiment of the present invention displays a message 2911 identifying a recognized smart cart. Moreover, the digital signage display 2910 automatically displays a list 2912 of items (or products) loaded in the recognized smart cart, after receiving the list 2912 from the server.

When a “Next” option, which is located in a lower area of a display screen shown in FIG. 29(a), is selected, the digital signage display 2920 according to the embodiment of the present invention outputs a message 2921 indicating the products that the user wishes to cancel, as shown in FIG. 29(b).

Evidently, in FIG. 29(b), in order to cancel some of the purchased products, the cancelling process may be performed by using the barcode reader attached to the shopping cart according to the embodiment of the present invention. Then, the cancelled products are removed from the shopping cart. In FIG. 29(b), it is assumed that the user has canceled 10 eggs and one tofu.

Therefore, as shown in FIG. 29(c), the digital signage display 2930 newly outputs the corrected payment list 2931. When comparing the payment list shown in FIG. 29(a) with the corrected payment list 2931 shown in FIG. 29(c), the user may easily verify that the 10 eggs and one tofu, which have been canceled, are deleted from the payment list.

The controlling method of the digital signage display, which has been described above with reference to FIG. 26 to FIG. 29, may be recapitulated as shown below.

The digital signage display may detect a specific shopping cart being equipped with a code reader, a memory, and a communication module, and may be controlled so that communication can be performed between the detected specific cart and the digital signage display.

Also, the digital signage display may receive first information and second information, all of the information being stored in a memory of the specific cart. Herein, the first information may correspond to unique ID data being assigned in order to enable the shopping cart to be identified among a plurality of other shopping carts existing in the supermarket. And, the second information may correspond to data indicating whether or not payment process for products loaded in the shopping cart can be performed.

Furthermore, the digital signage display may display a first message providing a user with guidance for performing the payment process respective to the products loaded in the shopping cart, when the second information indicates that the payment process can be performed.

Thereafter, the digital signage display may display a second message informing the user that the payment process respective to the products loaded in the shopping cart cannot be performed, when the second information indicates that the payment process cannot be performed. Also, according to another embodiment of the present invention, the step of displaying a second message may further include transmitting the second message to a server, and requesting the user to re-touch the products loaded in the shopping cart to a code reader.

Meanwhile, according to yet another embodiment of the present invention, the digital signage display may be designed to receive information on a list of products loaded in the shopping cart and information on a total payment amount (or charged sum) from a communication module of the shopping cart. At this point, the digital signage display may primarily display the received information on the list of products and the received information on the total payment amount, and may secondarily display a message providing the user with guidance for performing the payment process. This may be more easily understood by referring to the description of FIG. 28.

FIG. 30 illustrates a detailed block view showing an inner configuration module of a display device attachable to a shopping cart according to an exemplary embodiment of the present invention.

Hereinafter, the functions of the display device and the code reader, which may be detachably fixed to the shopping cart, will be described in detail with reference to FIG. 30.

As shown in FIG. 30, a display device 3000 attachable to a shopping cart includes a code reader 3010, a display module 3020, a main controller 3030, a touch sensor 3040, a memory 3050, a communication module 3060, and a weight detection sensor 3070. Evidently, the scope of the present invention also includes having the code reader 3010 and the weight detection sensor 3070 positioned outside of the display device 3000, instead of being configured as inner components of the display device 3000. Furthermore, the modules shown in FIG. 30 are merely exemplary, and, therefore, as a general rule, the scope of the present invention shall be decided by the appended claims of the present invention.

The communication module 3060 is designed to receive information on a specific product (or item) from a digital device displaying at least one or more products. The digital device will be described in more detail later on with reference to FIG. 17.

The code reader 3010 performs the role of recognizing code information attached to a random product. For example, the code reader 3010 corresponds to a barcode reader, a QR code scanner, an NFC tag scanner, and so on, each being capable of recognizing barcodes, QR codes, NFC tags, and so on.

The main controller 3030 compares the code information of the product recognized by the code reader 3010 with the received information on a specific product. The scope of the present invention may also include designing the present invention so that a separate module performing the above-described function can be included.

The display module 3020 displays a guidance message in accordance with a control signal generated from the main controller 3030. The scope of the present invention may also include allowing the user to select a random area of a screen, which is outputted through the display module 3020, by using the touch sensor 3040.

For example, information on the specific product includes at least one or more of weight information or code information of the specific product.

When the information on the specific product corresponds to weight information, the main controller 3030 is designed to compare an added weight, which is recognized by the weight detection sensor 3070, with the weight information of the specific product. For example, the weight detection sensor 3070 may be designed to be located in a specific area 1620 of the shopping cart, as shown in FIG. 16.

When the compared weights are identical to one another, the main controller 3030 stores data, which indicates that the payment process can be performed, in the memory 3050. And, when the compared weights are different from one another, the main controller 3030 stores data, which indicates that the payment process cannot be performed, in the memory 3050.

Based upon the control of the main controller 3030, when the compared weights are different from one another, the display module 3020 outputs a guidance message indicating that the payment process cannot be performed.

Also, when the compared weights are different from one another, the main controller 3030 generates a command signal directing wheels of the shopping cart to be changed to an enabled mode (or enable state).

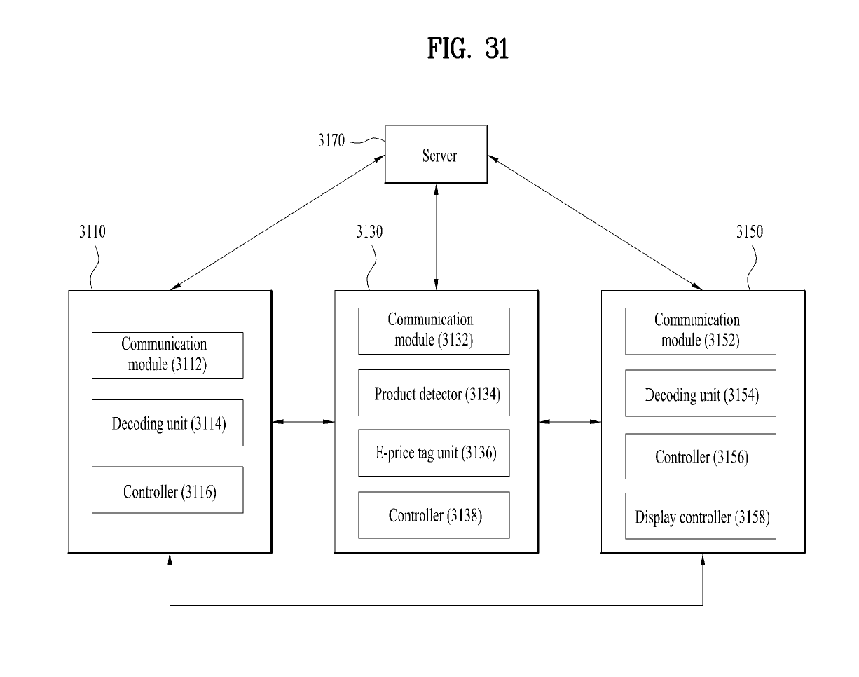

FIG. 31 illustrates a detailed block view showing a structure of a system for controlling a store according to the present invention.

The system for controlling a store includes a digital display shelf being provided with a recognition unit configured to recognize a product displayed on the shelf and an output unit configured to output information on the recognized product, a digital signage display configured to output data respective to the recognized product, and a managing system configured to communicate with the digital display shelf and the digital signage display so as to transmit control data and to receive processing data. Herein, the data respective to the recognized product may include at least one of audio data, video data, and text data configured to advertise and promote the corresponding product, and the managing system may include a database related to the data respective to the recognized product. Furthermore, the system for controlling the store may further include a server configured to communicate with the digital display shelf, the digital signage display, and the managing system, so as to transmit and receive data to and from the digital display shelf, the digital signage display, and the managing system.

The digital display shelf may further include a communication module configured to support wireless and/or wired communication and to transmit and receive data. The recognition unit included in the digital display shelf may include a detection sensor configured to sense a weight of a predetermined section of the display shelf. Herein, the recognition unit may communicate with the managing system, so as to receive product data respective to the sensed weight, thereby recognizing the corresponding product. Also, the recognition unit included in the digital display shelf may include a camera sensor or an infrared sensor configured to acquire an image of the product positioned in a predetermined section of the digital display shelf. Herein, the recognition unit may communicate with the managing system, so as to receive product data corresponding to the acquired image, thereby recognizing the corresponding product. Furthermore, the recognition unit included in the digital display shelf may include a sensor configured to acquire an image of the product positioned in a predetermined section of the digital display shelf. Herein, the recognition unit may communicate with the managing system, so as to receive product data respective to the sensed weight and corresponding to the acquired image, thereby recognizing the corresponding product. And, the output unit is configured to communicate with the managing system so as to receive electronic-price tag information, which is recognized by the recognition unit, and to output the received information to a predetermined section of the digital display shelf respective to the corresponding product in a text data format.

The digital signage display may include a communication module configured to support wireless and/or wired communication and to transmit and receive data, a decoding unit configured to decode data being received from the managing system and the digital display shelf through the communication module, and a display unit. Also, the digital signage display is divided into predetermined sections in row or column units based upon an alignment method of the products displayed on the digital display shelf. And, the digital signage display is configured to output data respective to at least one or more products displayed on the digital display shelf; the products corresponding to each of the divided sections. Furthermore, the digital signage display is also configured to communicate with a user terminal of a customer being recognized to be located within a predetermined range, receive at least one of customer information and purchase list information, and output data respective to a related product among a plurality of products recognized from the display shelf or data respective to a related product received from a managing system, based upon the at least one of the received customer information and purchase list information.

Referring to FIG. 31, an exemplary store controlling system 3100 may include a POS 3110, a smart-shelf 3130, and a digital signage display 3150. Herein, the store controlling system 3100 may either be provided with a server 3170 inside the system or may communicate with an external server so as to perform the required processing operations.

Herein, the POS 3110, which corresponds to a managing system for the entire store, may include a communication module 3112, a decoding unit 3114, and a controller 3116. Additionally, the POS 3110 essentially includes a display device.

The communication module 3112 may transmit and/or receive data to and/or from the smart-shelf 3130, the digital signage display 3150, and the server 3170.

Audio, video, and text data being received from the smart-shelf 3130, the digital signage display 3150, the server 3170, and also the decoding unit 3114 are decoded.

The controller 3116 may perform control operations so that the decoded data can be outputted to a display unit and may also control the management of the entire store including the transmission and/or reception of the related data.

The controller 3116 is also internally provided with a separate database, thereby being capable of storing data related to the store.

Herein, the data related to the store includes all types of information required for managing and controlling the store, such as position information of all smart-shelves, digital signage displays, and individual POSs provided in the store, as well as all facilities and equipments installed in the store, identification information respective to each smart-shelf and digital signage display, identification information respective to each product, basic information and additional information, such as name of product, product size, unit price, number of stored products (i.e., number of available products), number of sold products, and so on, information respective to the products positioned and displayed in each smart-shelf, payment related information, and so on.

The controller 3116 communicates with the server 3170 so as to periodically and/or aperiodically determine whether or not the data related to the store, which are stored in the internal database, have been updated. Then, based upon the determined result, the controller 3116 may download only the required data, thereby continuously updating the database.

Additionally, the POS 3110 may periodically and/or aperiodically communicate with the smart-shelf 3130 and/or the digital signage display 3150, so as to transmit and/or receive the respective data.

In relation with the payment process, the POS 3110 may communicate with an external payment server whenever required, so as to carry out and process the payment process.

The smart-shelf 3130 may be configured of a communication module 3132, a product detector 3134, an electronic-price tag unit (E-price tag unit) 3136, and a controller 3138. And, whenever required, the smart-shelf 3130 may also include a decoding unit configured to decode the respective data, and a memory configured to store the decoded data.

The communication module 3132 transmits and/or receives data to and/or from the POS 3110, the digital signage display 3150, and database cloud by performing wired and/or wireless communication.

The product detector 3134 consists of at least one of the above-described sensor, camera, and so on, and the product detector 3134 acquires data for recognizing products positioned and displayed on a predetermined section of a display shelf. The product detector 3134 transmits the acquired product recognition data to the database cloud, the POS 3110, the server 3170, and so on, so as to be capable of receiving the data for recognizing products or determining whether or not an error occurs in the product recognition data.

The E-price tag unit 3136 receives electronic-price data (or E-price data), which are acquired from the product detector 3134 and uploaded, or which are separately transmitted from the product detector 3134, from the database cloud, the POS 3110, the server 3170, and so on. And, then, the E-price tag unit 3136 outputs the received E-price data to a predetermined section of the display shelf.

The controller 3138 controls the overall process steps of the above-described procedure. And, when required, the controller 3138 may communicate with the server in real-time, so as to store the data acquired or received from the product detector 3134 and the E-price tag unit 3136. Alternatively, the controller 3138 may also process the corresponding data in the form of database and may store the converted database format data in an internal memory.

The digital signage display 3150 consists of a communication module 3152, a decoding unit 3154, a controller 3156, and a display controller 3158. Herein, the digital signage display 3150 may further includes a memory, which is configured to store required data. And, the digital signage display 3150 essentially includes a display device.

The communication module 3152 may communicate with the POS 3110, the smart-shelf 3130, the server 3170, and so on via wired and/or wireless communication, and the communication module 3152 may also communicate with other digital signage displays.

The decoding unit 3154 may decode data received from an outside source or data stored within the system into a format that can be outputted to the display device 3156.

The controller 3156 controls the overall process of the digital signage display 3150. And, the controller 3156 may also control the display controller 3158, so as to be capable of controlling the output of the data, which are decoded by the decoding unit 3154, being outputted through the display device.

The display controller 3158 is controlled by the controller so as to control the output of the processed data through the display device. The display controller 3158 may perform control operations enabling a related UI to be generated (or created) and outputted. Herein, for example, the display controller 3158 may perform control operations for outputting a UI having the same format as the digital signage display shown in FIG. 18 to FIG. 20 and also shown in FIG. 24 and FIG. 25.

The above-described controller 3156 and display controller 3158 may be configured of a single module or may be configured as separate modules, as shown in FIG. 31.

As described above, each of the POS 3110, the smart-shelf 3130, the digital signage display 3150, and the server 3170 may perform data transmission and/or reception between one another by using a close-range wireless communication network, such as ZigBee, Wi-Fi, Bluetooth, and so on, or by using a wired communication network, such as TCP/IP, LAN, and so on.

The above-described store controlling system and method for the same have the following advantages. First of all, the present invention may perform a two-way information exchange with a user or a user terminal by using a digital interface, which performs interfacing with the user or the user terminal, and/or may control the store (or supermarket) by using a managing system that can communicate with the digital interface. Secondly, by using the digital interface and the managing system, the present invention may provide a faster and smarter payment method and payment system. Thirdly, by providing a user interface of the digital interface that can be easily and conveniently used by the user or the user terminal, the system according to the present invention may easily communicate with the user or the user terminal, and the store may be easily controlled.

Fourthly, by using a digital signage display, which corresponds to a digital interface, as a virtual display shelf, the present invention may enhance space efficiency and time efficiency. Fifthly, the overall efficiency of the store (or supermarket) may be maximized, and the system according to the present invention may provide a greater level of shopping convenience to the users visiting the store. Sixthly, the present invention may define a communication protocol between a digital device displaying the products located in the supermarket and a display device mounted on shopping carts of a supermarket. Seventhly, the present invention may also provide a digital system that can prevent products or items located (or displayed) in each aisle of the corresponding supermarket from being lost or stolen. Finally, the present invention may define and provide a communication method of a digital signage and a user interface that can replace the large number of employees working in the corresponding supermarket, thereby minimizing the payment process.

Furthermore, although the drawings have been distinguished and divided in order to facilitate the description of the present invention, the present invention may be designed to form a new embodiment by combining some of the above-described embodiments of the present invention. Moreover, whenever required by anyone skilled in the art, the scope of the present invention includes designing a recording medium readable by a computer, the computer having a program for executing the above-described embodiments of the present invention recorded therein.

The display device and the method for operating the same according to the present invention may not be limited only to the above-described configuration and methods according to the exemplary embodiments of the present invention. Accordingly, variations of the exemplary embodiments of the present invention may be configured by selectively combining each exemplary embodiment of the present invention fully or in part.

Meanwhile, the method of operating the display apparatus according to the present invention may be realized as a code that can be read by a processor provided in the image display device in a recording medium that can be read by a processor. The recording medium that can be read by the processor includes all types of recording devices storing data that can be read by the processor. Examples of the recording media that can be read by a processor may include ROMs, RAMs, CD-ROMs, magnetic tapes, floppy disks, optical data storing devices, and so on. Also, an exemplary recording medium being realized in the form of a carrier wave, such as a transmission via Internet, may also be included. Also, the recording medium that can be read by a processor may be scattered within a computer system, which is connected through a network. And, a code that can be read by the processor may be stored and executed by using a dispersion (or scattering) method.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents. It is also apparent that such variations of the present invention are not to be understood individually or separately from the technical scope or spirit of the present invention.

Also, a device invention and a method invention are both described in this specification of the present invention. Therefore, whenever required, the description of both inventions may be supplementarily applied.

1. A method of controlling a store of a store controlling system, the store controlling system comprising a digital signage display configured to communicate with a user or a user terminal and to provide a user interface, and a managing system configured to communicate with the digital signage display, so as to manage and control the store, the method comprising:
authenticating the user or the user terminal;
receiving information on a purchase list;
outputting product information based upon the received purchase list information;
receiving a selection input for purchasing at least one product;
generating payment information based upon a basic unit price and a quantity of the at least one product being selected for purchase, and outputting the generated payment information; and
processing payment, and controlling a release of the at least one purchased product, when the payment process is completed.

2. The method of claim 1, wherein, in the step of receiving information on a purchase list, the digital signage display or the managing system receives the information on the purchase list by having the user input the corresponding information by touching a display screen of the digital signage display, or by communicating with the authenticated user terminal,
wherein, in the step of outputting product information, the outputted product information includes at least one of video data, audio data, and text data, and
wherein the text data includes data corresponding to at least one of product name, unit price, quantity, location, coupon, expiration date.

3. The method of claim 2, wherein, in the step of receiving a selection input, the selection input further include a payment method for purchasing the selected product,
wherein the payment method includes an online payment method and an offline payment method, the online payment method being processed online through the digital signage display or the managing system within the store, and the offline payment method being directly carried out by the user within the store, and
wherein the payment information is generated for a product selected to be purchased by the online payment method, or wherein the payment information is generated for all products selected to be purchased by both the online payment method and the offline payment method.

4. The method of claim 3, wherein, in the step of receiving a selection input, when the user selects the offline payment method for a specific product, at least one of location information on the specific product and movement path information from a current location to a location where the specific product is displayed is downloaded, and
wherein the user terminal, the digital signage display, and the managing system exchange information to and from one another by using a wired and/or wireless communication protocol.

5. A system for controlling a store, comprising:
a user terminal configured to include customer information and purchase list information;
a digital signage display configured to deliver the customer information and purchase list information to a managing system, and to output product information based upon the purchase list information; and
a managing system configured to authenticate a customer based upon the customer information, to generate payment information based upon a basic unit price and quantity of a product selected from the purchase list information and to provide the generated payment information, and to control a release of a purchased product, when a payment process of the product selected for purchase is completed.

6. The system of claim 5, wherein the digital signage display or the managing system directly receives the purchase list information by having the user input the corresponding information by touching a display screen of the digital signage display, or by downloading the purchase list information from the authenticated user terminal through a network by using a pre-decided communication protocol,
wherein the digital signage display outputs product information, the outputted product information including at least one of video data, audio data, and text data, and
wherein the text data includes data corresponding to at least one of product name, unit price, quantity, location, coupon, expiration date.

7. The system of claim 6, wherein the digital signage display receives a selection input on a payment method for each product included in the purchase list information, the purchase list information being received from the user terminal, and
wherein the payment method includes an online payment method and an offline payment method, the online payment method being processed online through the digital signage display or the managing system within the store, and the offline payment method being directly carried out by the user within the store.

8. The system of claim 7, wherein, when the user selects the offline payment method for a specific product, the digital signage display downloads at least one of location information on the specific product and movement path information from a current location to a location where the specific product is displayed.

9. The system of claim 8, wherein the managing system generates the payment information for a product selected to be purchased by the online payment method, or wherein the managing system generates the payment information for all products selected to be purchased by both the online payment method and the offline payment method.

10. The system of claim 9, wherein the user terminal, the digital signage display, and the managing system exchange information to and from one another by using a wired and/or wireless communication protocol.

11. A digital signage display configured to communicate with a user or user terminal within a store controlling system and to communicate with a managing system configured to manage and control a store, the digital signage display comprising:
a communication module configured to communicate with the user terminal and the managing system; and
a control module configured to perform control operations for aligning information on each product in row or column units, the information being received from the managing system, and for outputting the product information based upon the controlled alignment, and, when a specific product is selected, to perform control operations for outputting a user interface and related information respective to the selected product,
wherein the product information comprises at least one of video data including images of the corresponding product, audio data, and text data, and
wherein the text data includes information on a basic unit price of the corresponding product.

12. A display device attachable to a shopping cart, comprising:
a communication module configured to receive information on a specific product from a digital device displaying at least one or more products;
a code reader configured to recognize code information attached to a random product;
a comparison module configured to compare the code information of a product recognized by the code reader with information on the received information on the specific product;
a controller configured to generate a first control signal, when it is determined that the information are identical, and to generate a second control signal, when it is determined that the information are not identical; and
a display module configured to display a guidance message based upon any one of the control signals generated by the controller.

13. The display device of claim 12, wherein the information on the specific product includes at least any one of weight information and code information of the specific product.

14. The display device of claim 13, wherein, when the information on the specific product corresponds to the weight information, the comparison module compares an added weight recognized by a weight detection sensor with the weight information of the corresponding specific product.

15. The display device of claim 12, wherein, when the information are identical, the controller stores in a memory data indicating that a payment process can be performed,
wherein, when the information are not identical, the controller stores in the memory data indicating that a payment process cannot be performed, and
wherein, when the information are not identical, the controller generates a control signal directing wheels of the shopping cart to be in an enabled state.

16. The display device of claim 15, wherein, based upon a control of the controller, when the information are not identical, the display module outputs a guidance message indicating that the payment process cannot be performed.

17. A method for controlling a digital signage display located in a supermarket, comprising:
detecting a specific shopping cart being equipped with a code reader, a memory, and a communication module;
controlling the digital signage display so that communication can be performed between the detected specific cart and the digital signage display;
receiving first information and second information, both information being stored in a memory of the specific cart, wherein the first information corresponds to unique ID data being assigned in order to enable the shopping cart to be identified among a plurality of other shopping carts existing in the supermarket, and wherein the second information corresponds to data indicating whether or not payment process for products loaded in the shopping cart can be performed;
displaying a first message providing a user with guidance for performing the payment process respective to the products loaded in the shopping cart, when the second information indicates that the payment process can be performed; and
displaying a second message informing the user that the payment process respective to the products loaded in the shopping cart cannot be performed, when the second information indicates that the payment process cannot be performed.

18. The method of claim 17, further comprising:
receiving information on a list of products loaded in the shopping cart and information on a total payment amount from a communication module of the shopping cart.

19. The method of claim 18, wherein the step of displaying a first message comprises:
primarily displaying the received information on the list of products and the received information on the total payment amount; and
secondarily displaying a message providing the user with guidance for performing the payment process.

20. The method of claim 17, wherein the step of displaying a second message comprises:
transmitting the second message to a server; and
requesting the user to re-touch the products loaded in the shopping cart to a code reader.
